(19) United States
(12) Patent Application Publication
(10) Pub. No.: US 2016/0028277 A1
(43) Pub. Date: Jan. 28, 2016

(54) MULTI-LUNDELL MOTOR

(71) Applicant: ASMO CO., Ltd., Shizuoka-ken (JP)

(72) Inventors: Yoshiaki Takemoto, Toyohashi-shi (JP); Seiya Yokoyama, Toyohashi-shi (JP); Masashi Matsuda, Kakegawa-shi (JP); Shigemasa Kato, Toyohashi-shi (JP)

(73) Assignee: ASMO CO., LTD., Shizuoka-ken (JP)

(21) Appl. No.: 14/800,424

(22) Filed: Jul. 15, 2015

(30) Foreign Application Priority Data
Jul. 23, 2014 (JP) 2014-149980
Sep. 24, 2014 (JP) 2014-193966
Feb. 24, 2015 (JP) 2015-034406
Jul. 7, 2015 (JP) 2015-136092

(51) Int. Cl. H02K 1/24; H02K 1/14; H02K 1/27

(52) U.S. Cl. CPC H02K 1/243; H02K 1/2713; H02K 1/145

(57) ABSTRACT

A multi-Lundell motor includes a rotor and a stator. The rotor includes first and second rotor cores and a permanent magnet. The first and second rotor cores each include claw poles in the circumferential direction. The permanent magnet is magnetized in the axial direction between the first and second rotor cores. The stator includes first and second stator cores and a winding. The first and second stator cores each include claw poles in the circumferential direction. The winding is arranged between the first and second stator cores and extended in the circumferential direction. At least one of the first and second rotor cores and the first and second stator cores include core segments arranged in the circumferential direction.

### BACKGROUND OF THE INVENTION

The present invention relates to a multi-Lundell motor.

A known Lundell motor includes a Lundell rotor. The Lundell rotor includes two rotor cores, each having claw poles arranged in the circumferential direction, and permanent magnets arranged between the rotor cores. The permanent magnets function so that the claw poles have magnetic poles that differ alternately. Japanese Laid-Open Patent Publication No. 2013-226026 describes a Lundell motor that includes a Lundell stator in addition to a Lundell rotor. The Lundell stator includes two stator cores, each having claw poles arranged in the circumferential direction, and an annular winding arranged between the stator cores. The annular winding functions so that the claw poles have magnetic poles that differ alternately. This Lundell motor type is referred to as a multi-Lundell motor since the rotor and the stator are both of Lundell types.

A multi-Lundell motor allows the number of poles to be changed by changing the number of claw poles. Thus, the feature of the multi-Lundell motor is in that the number of poles can be increased.

In the above motor, for example, the core base of the rotor core and the core base of the stator core may be punched out of a plate into an annular shape. In this case, claws, which become the claw poles, are simultaneously punched out with the core bases and then bent 90 degrees to form the claw poles.

However, the core bases are relatively large in size. Thus, when the annular core bases are simply punched out from a plate, the yield would be low. Thus, there is room for improvement.

### SUMMARY OF THE INVENTION

It is an object of the present invention to provide a multi-Lundell motor that increases the yield.

To achieve the above object, one aspect of the present invention is a multi-Lundell motor including a rotor and a stator. The rotor includes first and second rotor cores, each including a plurality of claw poles in a circumferential direction, and a permanent magnet, which is located between the first and second rotor cores and magnetized in an axial direction. The stator includes first and second stator cores, each including a plurality of claw poles in the circumferential direction, and a winding, which is located between the first and second stator cores and extended in the circumferential direction. At least one of the first and second rotor cores and the first and second stator cores include a plurality of core segments arranged in the circumferential direction.

### BRIEF DESCRIPTION OF THE DRAWINGS

FIG. 1 is a perspective view of a motor according to a first embodiment of the present invention.

FIG. 2 is a perspective view of a rotor shown in FIG. 1.

FIG. 3 is an exploded perspective view of a rotor unit shown in FIG. 2.

FIG. 4 is a perspective view of a U-phase and W-phase rotor unit shown in FIG. 2.

FIG. 5 is a perspective view of a V-phase rotor unit shown in FIG. 2.

FIG. 6 is a developed view showing the outer circumference of the rotor of FIG. 2 laid out on a flat surface.

FIG. 7 is a cross-sectional perspective view of a stator shown in FIG. 1.

FIG. 8 is an exploded perspective view of a stator unit shown in FIG. 7.

FIG. 9 is a developed view showing the inner circumference of the stator of FIG. 7 laid out on a flat surface.

FIG. 10 is a perspective view showing a stator in a modified example of the first embodiment.

FIG. 11 is a perspective view showing a stator in a modified example of the first embodiment.

FIG. 12 is a perspective view of a motor illustrating a stator in a modified example of the first embodiment.

FIG. 13 is a perspective view illustrating a core segment and a resin portion in a modified example of the first embodiment.

FIG. 14 is a plan view illustrating a core segment and a resin portion in a modified example of the first embodiment.

FIG. 15 is a perspective view of a motor in a modified example of the first embodiment.

FIG. 16 is a perspective view illustrating a core segment in a modified example of the first embodiment.

FIG. 17 is a plan view illustrating the core segment shown in FIG. 16.

FIG. 18 is an end elevation view of a stator unit to which a core segment is coupled.

FIG. 19 is a plan view illustrating a core segment in a modified example of the first embodiment.

FIG. 20 is a perspective view illustrating the connection relationship of a winding and a core segment in a modified example of the first embodiment.

FIG. 21 is a perspective view illustrating the connection relationship of a winding and a terminal in a modified example of the first embodiment.

FIG. 22 is a perspective view illustrating the connection relationship of the winding and the terminal shown in FIG. 21.

FIG. 23 is a perspective view of a stator unit illustrating a winding in a modified example of the first embodiment.

FIG. 24 is a perspective view of the winding shown in FIG. 23.

FIG. 25 is a perspective view illustrating a portion of a conductor segment forming the winding shown in FIG. 24.

FIG. 26 is a perspective view illustrating a circuit section arranged between conductor segments forming the winding shown in FIG. 24.

FIG. 27 is a partially exploded perspective view of a stator unit in a modified example of the first embodiment.

FIG. 28 is a perspective view of a stator unit in a modified example of the first embodiment.

FIG. 29 is a perspective view illustrating the connection relationship of a winding and a terminal shown in FIG. 28.

FIG. 30 is a perspective view illustrating the connection relationship of the winding and the terminal shown in FIG. 29.

FIG. 31 is a perspective view of a motor according to a second embodiment of the present invention.

FIG. 32 is an exploded perspective view of the motor in which a stator shown in FIG. 31 is partially cut.

FIG. 33 is an exploded front view of the motor taken in the radial direction in which the stator shown in FIG. 31 is partially cut.

FIG. 34 is a perspective view of a motor unit in the motor shown in FIG. 31.

FIG. 35 is a cross-sectional view of the motor unit shown in FIG. 34 taken in the radial direction.

FIG. 36 is an exploded perspective view of a rotor unit shown in FIG. 34.

FIG. 37 is an exploded perspective view of a stator unit shown in FIG. 34.

### DETAILED DESCRIPTION OF THE PREFERRED EMBODIMENTS

A first embodiment of a multi-Lundell motor will now be described.

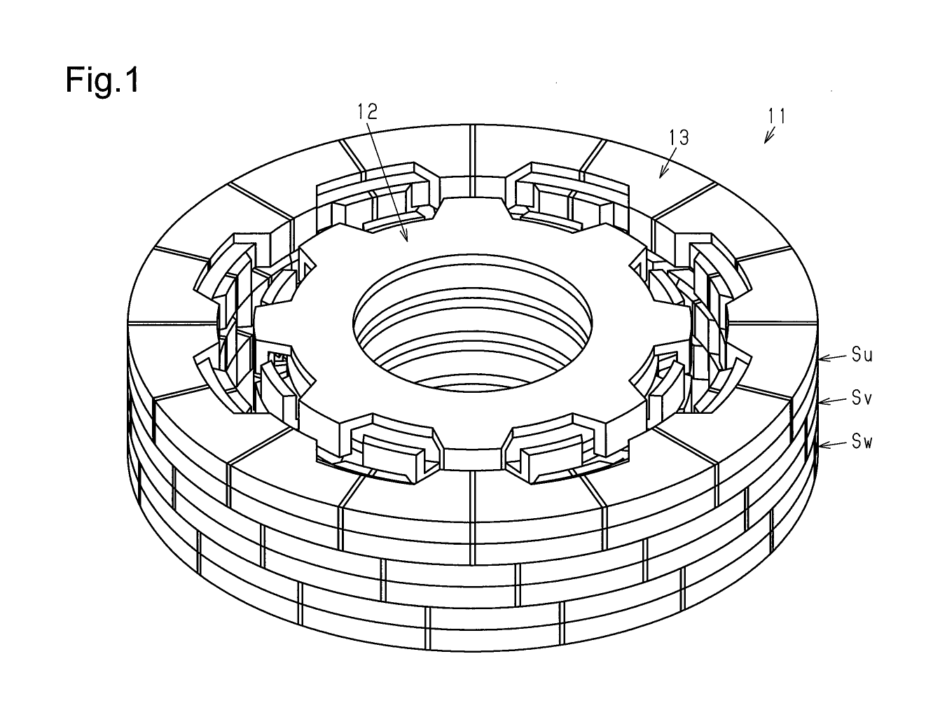

As shown in FIG. 1, in the present embodiment, a motor 11 includes a rotor 12, which is fixed to a rotation shaft (not shown), and an annular stator 13, which is arranged at the outer side of the rotor 12 and fixed to a motor housing (not shown).

Structure of Rotor

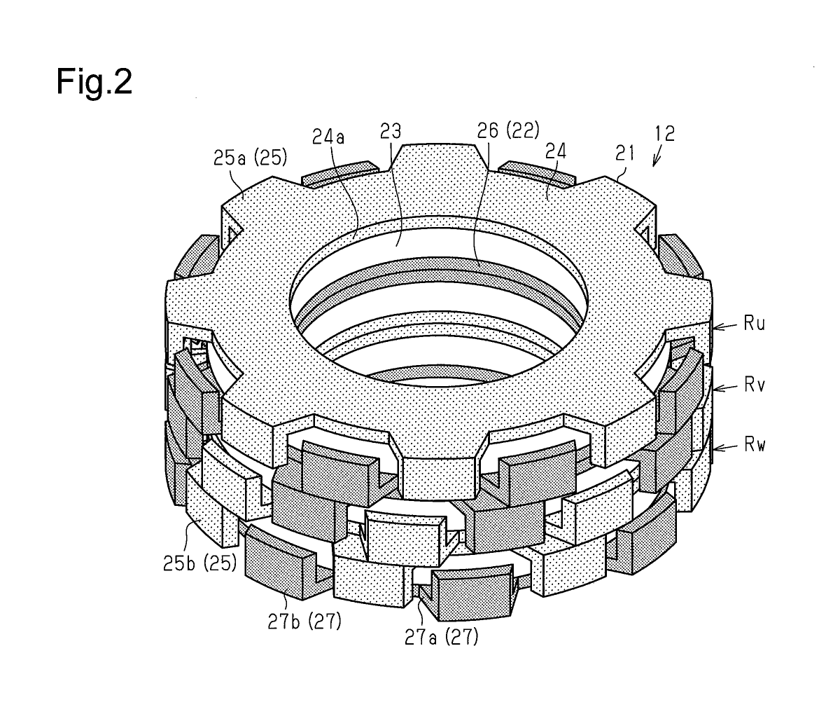

As shown in FIG. 2, the rotor 12 includes a U-phase rotor unit Ru, a V-phase rotor unit Rv, and a W-phase rotor unit Rw, which are sequentially stacked in the axial direction. The rotor units Ru, Rv, and Rw have similar structures.

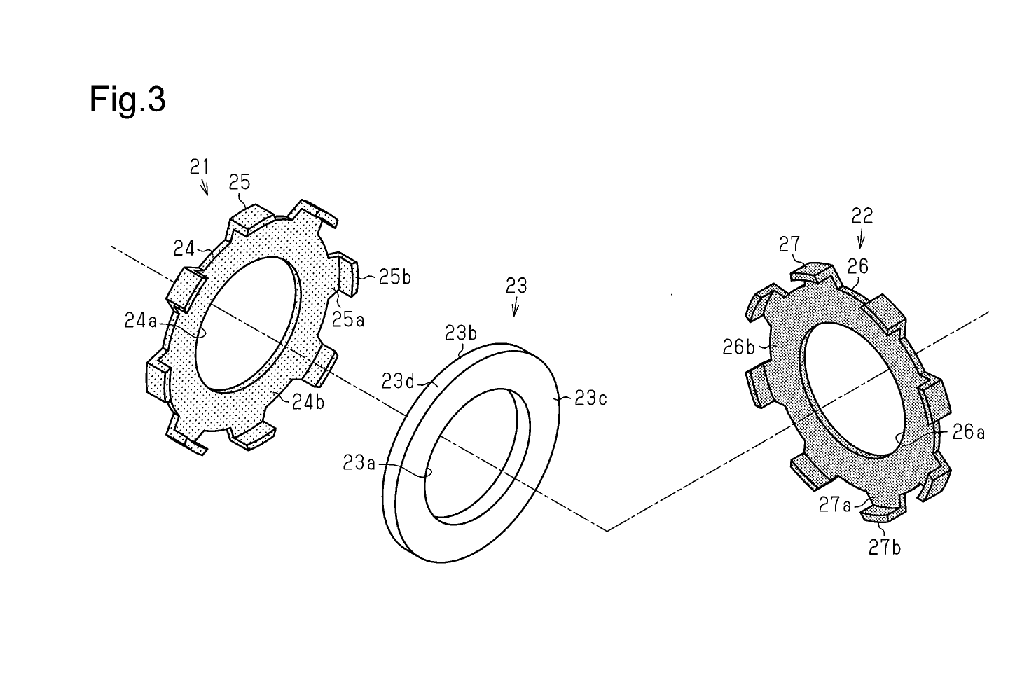

As shown in FIGS. 2 and 3, the rotors Ru, Rv, and Rw each include first and second rotor cores 21 and 22 and a field magnet 23, which is located between the first and second rotor cores 21 and 22.

The first rotor core 21 includes a disk-shaped first rotor core base 24. A through hole 24a extends through a radially central portion of the first rotor core base 24. The rotation shaft is inserted through and fixed to the through hole 24a. Eight first rotor claw poles 25 are arranged at equal intervals (45-degree intervals) on the outer circumference of the first rotor core base 24.

Each first rotor claw pole 25 includes a radial extension 25a, which extends toward the outer side in the radial direction from the outer circumference of the first rotor core base 24, and a first pole 25b, which projects from the distal end (outer end in the radial direction) of the radial extension 25a. The first rotor claw pole 25 may be formed by bending the first pole 25b at a right angle relative to the radial extension 25a. Alternatively, casting may be performed to integrally form the radial extension 25a and the first pole 25b.

The radial extension 25a is trapezoidal and narrowed toward the outer side in the radial direction as viewed in the axial direction. The first pole 25b is formed to be rectangular as viewed in the radial direction. Further, the two circumferential side surfaces of the first rotor claw pole 25, which includes the radial extension 25a and the first pole 25b, are each flat and approach each other at outer locations in the radial direction. The first rotor claw pole 25 is symmetric with respect to a line extending through the circumferential center of the first rotor claw pole 25. The radially outer surface of each first pole 25b is arcuate and lies along a circle that is concentric with the rotor 12 as viewed in the axial direction.

As shown in FIG. 3, the second rotor core 22, which has substantially the same shape as the first rotor core 21, includes a second rotor core base 26 and second rotor claw poles 27. The second rotor core base 26 (through hole 26a) and the second rotor claw poles 27 (radial extensions 27a and second poles 27b) are each substantially identical in shape to the first rotor core base 24 (through hole 24a) and the first rotor claw poles 25 (radial extensions 25a and second poles 25b).

As shown in FIG. 2, the first rotor core 21 and the second rotor core 22 are coupled to each other so that the distal ends of the poles 25b and 27b are directed in opposite axial directions. Each second pole 27b is located between the first poles 25b in the circumferential direction. When coupled, the first poles 25b and the second poles 27b are alternately arranged in the circumferential direction and located at equal intervals in the circumferential direction.

When the first and second rotor cores 21 and 22 are coupled, the first and second rotor core bases 24 and 26 are parallel to each other. Further, the field magnet 23 is arranged between the first and second rotor core bases 24 and 26.

Referring to FIG. 3, the field magnet 23 is a disk-shaped permanent magnet formed by, for example, a ferrite sintered magnet. The through hole 23a extends through the central portion of the field magnet 23. The rotation shaft is inserted through the through hole 23a. One end surface 23b of the field magnet 23 is in contact with an axially inner surface 24b of the first rotor core base 24. The other end surface 23c of the field magnet 23 is in contact with an opposing surface 26b of the second rotor core base 26. The field magnet 23 is held and fixed between the first rotor core base 24 and the second rotor core base 26 in the axial direction. The outer diameter of the field magnet 23 conforms to the outer diameters of the core bases 24 and 26.

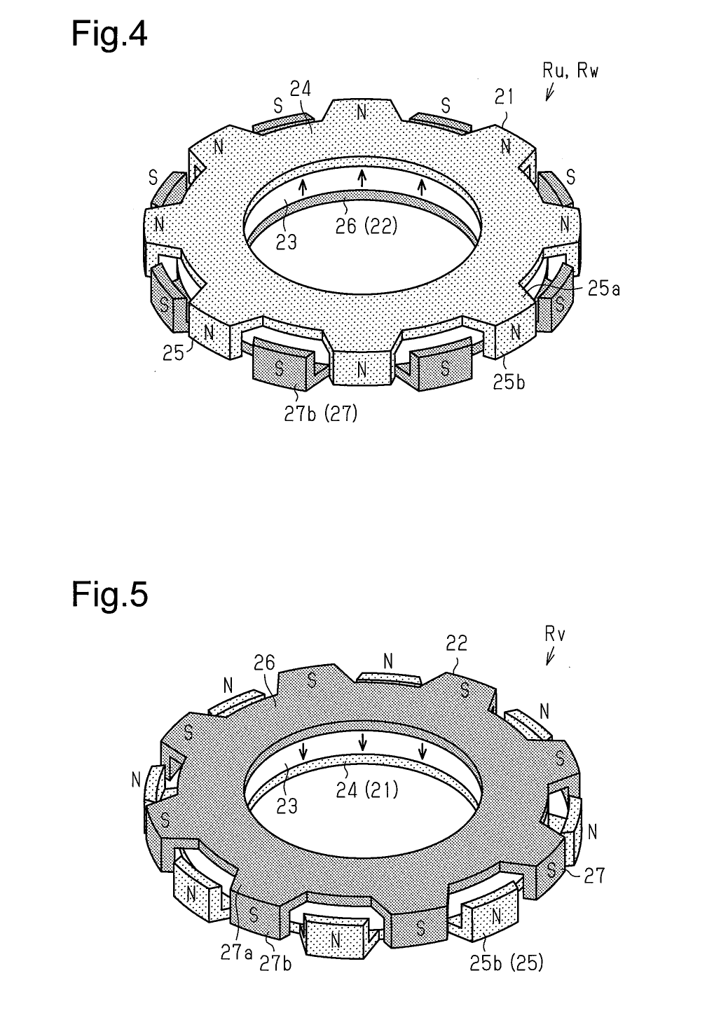

In FIG. 4, the arrows in solid lines indicate the magnetizing direction of the field magnet 23 (direction from S pole to N pole). As shown in FIG. 4, the field magnet 23 is magnetized in the axial direction so that the portion closer to the first rotor core base 24 is the N pole and the portion closer to the second rotor core base 26 is the S pole. Accordingly, due to the field magnet 23, each first rotor claw pole 25 functions as the N pole, and each second rotor claw pole 27 functions as the S pole.

The stacked structure of the rotor units Ru, Rv, and Rw will now be described.

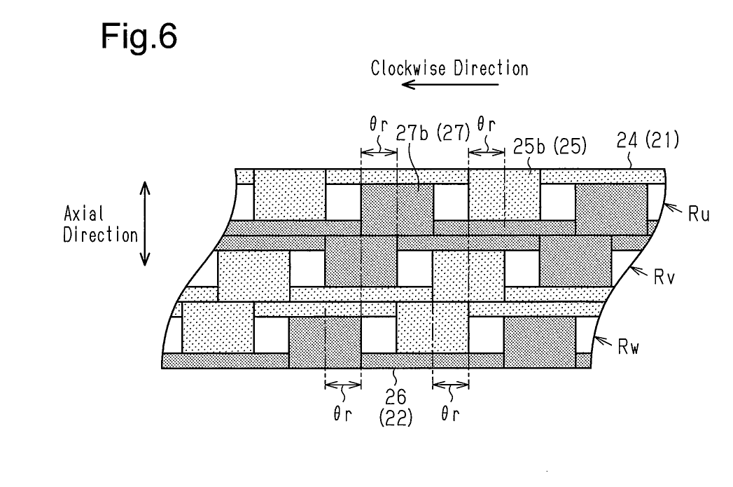

As shown in FIGS. 2 and 6, the U-phase rotor unit Ru, the V-phase rotor unit Rv, and the W-phase rotor unit Rw are sequentially stacked in the axial direction to form the rotor 12.

The U-phase and W-phase rotor units Ru and Rw are stacked so that the first rotor cores 21 are located at the upper side, and the V-phase rotor unit Rv is stacked so that the second rotor core 22 is located at the upper side. Thus, the middle V-phase rotor unit Rv is stacked reversed to the upper and lower U-phase and W-phase rotor units Ru and Rw (refer to FIGS. 4 and 5). As a result, the second rotor core bases 26 of the U and V-phases are adjacent to each other in the axial direction, and the first rotor core bases 24 of the V and W-phases are adjacent to each other in the axial direction.

The U-phase and W-phase field magnets 23 are magnetized in the same direction (upper direction as viewed in FIG. 6), and the V-phase field magnet 23 is magnetized in a direction opposite to the magnetizing direction of the U-phase and V-phase field magnets 23. In detail, the S poles of the U-phase and V-phase field magnets 23 are opposed to each other through the two adjacent first rotor core bases 24. Further, the N poles of the V-phase and W-phase field magnets 23 are opposed to each other through the two adjacent first rotor core bases 24. In this manner, the field magnets 23 of adjacent phases are axially magnetized in opposite directions.

The first poles 25b (first rotor claw poles 25) of the U-phase and W-phase rotor units Ru and Rw project in the same direction (lower direction in FIG. 6). In contrast, the first poles 25b of the V-phase project in a direction (upper direction in FIG. 6) that is opposite to the first poles 25b of the U-phase and W-phase rotor units Ru and Rw.

In the same manner, the second poles 27b (second rotor claw poles 27) of the U-phase and W-phase rotor units Ru and Rw project in the same direction (upper direction in FIG. 6). In contrast, the second poles 27b of the V-phase project in the opposite direction (lower direction in FIG. 6).

The rotor units Ru, Rv, and Rw are stacked sequentially shifting the phases by a shift angle of θr. In detail, the shift angle θr of the rotor units Ru, Rv, and Rw is set to 60 degrees in electrical angle (mechanical angle of 7.5 degrees). The V-phase rotor unit Rv is shifted by a phase of 60 degrees in electrical angle (7.5 degrees in mechanical angle) from the U-phase rotor unit Ru in the clockwise direction. Further, the W-phase rotor unit Rw is shifted by a phase of 60 degrees in electrical angle (7.5 degrees in mechanical angle) from the V-phase rotor unit Rv in the clockwise direction.

Structure of Stator

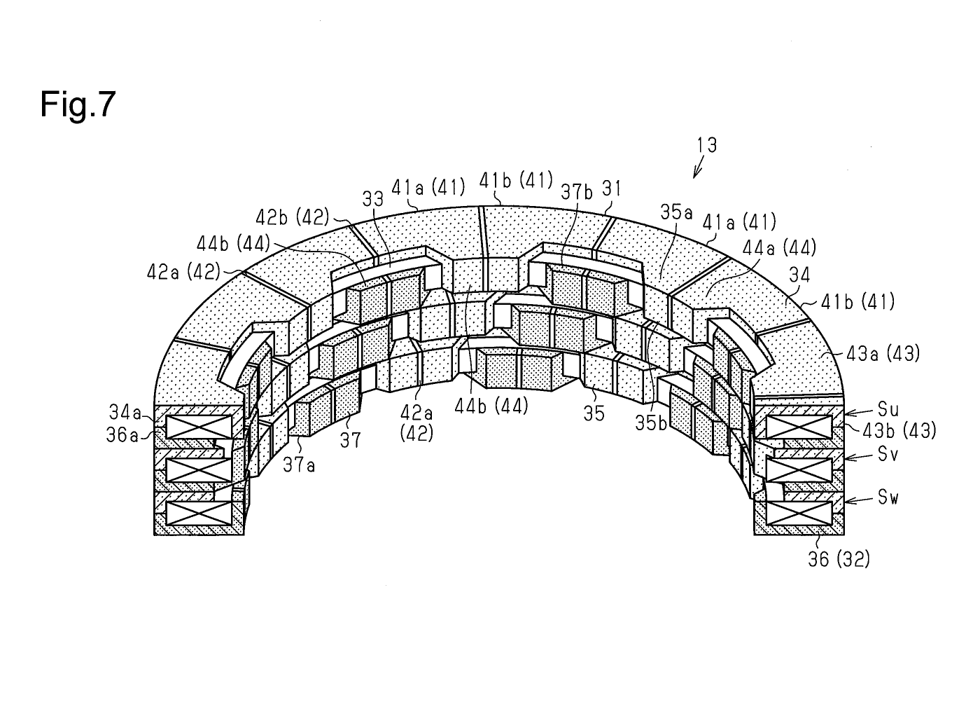

As shown in FIG. 7, the stator 13 arranged at the outer side of the rotor 12 in the radial direction includes stator units Su, Sv, and Sw for three phases (U-phase, V-phase, and W-phase) that are stacked in the axial direction in correspondence with the rotor units Ru, Rv, and Rw. The stator units Su, Sv, and Sw have substantially the same structure and each include first and second stator cores 31 and 32 and a winding 33, which is arranged between the first and second stator cores 31 and 32 in the axial direction.

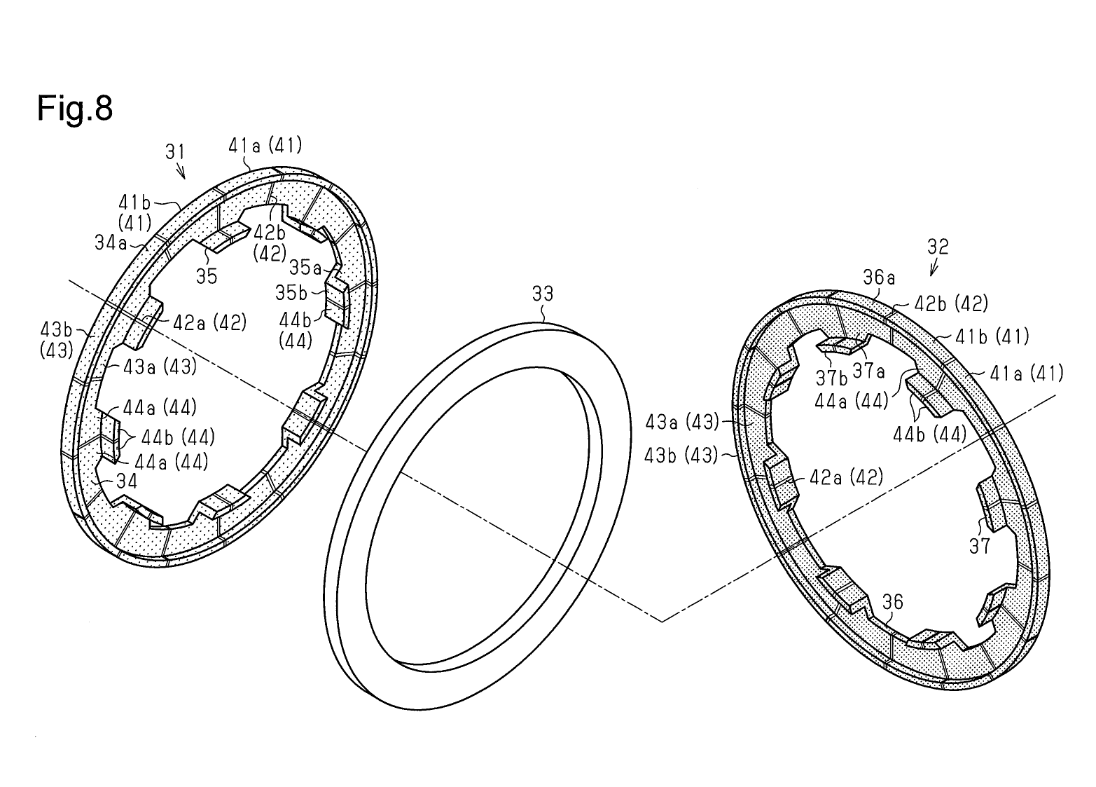

As shown in FIGS. 7 and 8, the first stator core 31 includes core segments 41, which are arranged in the circumferential direction, and resin portions 42, which are arranged between the core segments 41. The first stator core 31 is formed to be generally annular by the core segments 41 and the resin portions 42.

The core segments 41 include first core segments 41a and second core segments 41b. The first core segments 41a and the second core segments 41b each include an arc 43 and an extension 44.

The arc 43 includes a flat portion 43a and an axial extension piece 43b, which is located at the radially outer end of the flat portion 43a and extends in the axial direction. The axial extension piece 43b is arcuate as viewed in the axial direction. Thus, the arc 43 has an L-shaped circumferential end surface.

The extension 44 includes a radial extension piece 44a, which extends from the arc 43, and a claw piece 44b, which extends from the radial extension piece 44a in the axial direction. Thus, the extension 44 has an L-shaped circumferential end surface.

The first core segment 41a is shaped so as to be biased toward a first circumferential side of the arc 43. Thus, the end surface at the first circumferential side of the first core segment 41a is generally U-shaped (recessed) and joins the generally L-shaped end surface of the arc 43 and the generally L-shaped end surface of the extension 44. The end surface at the second circumferential side of the first core segment 41a includes only the arc 43 and is thus generally L-shaped.

The second core segment 41b is shaped so as to be biased toward a second circumferential side of the arc 43. Thus, the end surface at the second circumferential side of the second core segment 41b is generally U-shaped (recessed) and joins the generally L-shaped end surface of the arc 43 and the generally L-shaped end surface of the extension 44. The end surface at the first circumferential side of the second core segment 41b includes only the arc 43 and is thus generally L-shaped.

The resin portions 42 are located between the first core segments 41a and the second core segments 41b.

The resin portions 42 includes first resin portions 42a, which are located between the first circumferential end surfaces of the first core segments 41a and the second circumferential end surfaces of the second core segments 41b, and second resin portions 42b, which are located between the second circumferential end surfaces of the first core segments 41a and the first circumferential end surfaces of the second core segments 41b.

The first resin portions 42a and the second resin portions 42b each include an end surface shaped identically to the end surfaces of the core segments 41a and 41b that are in contact with the resin portion in the circumferential direction. That is, the first resin portion 42a is formed to be generally U-shaped (recessed) as viewed in the circumferential direction. The second resin portion 42b is formed to be generally L-shaped as viewed in the circumferential direction.

The core segments 41a and 41b and the resin portions 42 form a first stator core base 34 and first stator claw poles 35.

The first stator core base 34 is formed to be generally annular by the arcs 43 of the core segments 41a and 41b and the resin portions 42. The first stator core base 34 is formed as a plate having a plane that is orthogonal to the axial direction. Further, the first stator core base 34 includes a cylindrical wall 34a that extends in the axial direction from the outer circumference of the first stator core base 34. The cylindrical wall 34a is formed by the axial extension pieces 43b of the arcs 43 and the resin portions 42.

Eight first stator claw poles 35 are formed at equal intervals (45-degree intervals) on the inner circumference of the first stator core base 34. The first stator claw poles 35 are formed by the extensions 44 of the core segments 41a and 41b and the first resin portions 42a.

The first stator claw poles 35 each include a radial extension 35a, which extends from the inner circumference of the first stator core base 34 toward the inner side in the radial direction, and a first pole 35b, which projects from the distal end (radially inner end) of the radial extension 35a toward one axial side. The first stator claw pole 35 is symmetric with respect to a line extending through the circumferential center of the first stator claw pole 35.

The radial extension 35a is trapezoidal and narrowed toward the inner side in the radial direction as viewed in the axial direction. The radial extension 35a is formed by the radial extension pieces 44a of the core segments 41a and 41b and the first resin portions 42a.

The first pole 35b is formed to be rectangular as viewed in the radial direction. More specifically, the two circumferential ends of the radial inner surface (surface opposing rotor 12) of the first pole 35b extend straight along the axial direction. The first pole 35b is formed by the claw pieces 44b of the core segments 41a and 41b and the first resin portion 42a. In the first stator core 31 of the present embodiment, the first resin portions 42a are arranged at the centers of the corresponding first stator claw poles 35 in the circumferential direction, and the second resins 42b are located between adjacent ones of the first stator claw poles 35.

As shown in FIG. 8, the second stator core 32 has substantially the same shape as the first stator core 31 and includes a second stator core base 36 and second stator claw poles 37. The second stator core base 36 (cylindrical wall 36a) and the second stator claw poles 37 (radial extensions 37a and second poles 37b) are substantially identical in shape as the first stator claw poles 35 (radial extensions 35a and first poles 35b). Further, in the second stator core 32 of the present embodiment, the first resin portions 42a are located at the circumferential centers of the corresponding second stator claw poles 37, and the second resin portions 42b are located between adjacent ones of the second stator claw poles 37.

As shown in FIG. 7, the first stator core 31 and the second stator core 32 are coupled so that the distal ends of the poles 35b and 37b are directed in opposite axial directions, and the second poles 37b are arranged between the first poles 35b in the circumferential direction. The first poles 35b and the second poles 37b are arranged alternately in the circumferential direction when coupled and located at equal intervals in the circumferential direction.

When coupled, the first and second stator core bases 34 and 36 are parallel to each other. Further, the cylindrical walls 34a and 36a of the first and second stator core bases 34 and 36 come into contact in the axial direction and form outer circumferential walls of the stator units Su, Sv, and Sw. The winding 33, which is annular and extended in the circumferential direction, is arranged between the first and second stator core bases 34 and 36 in the axial direction.

The stator units Su, Sv, and Sw have an eight-pole Lundell (claw pole) structure in which the winding 33 excites the first and second stator claw poles 35 and 37 to different poles.

The stacking structure of the stator units Su, Sv, and Sw will now be described.

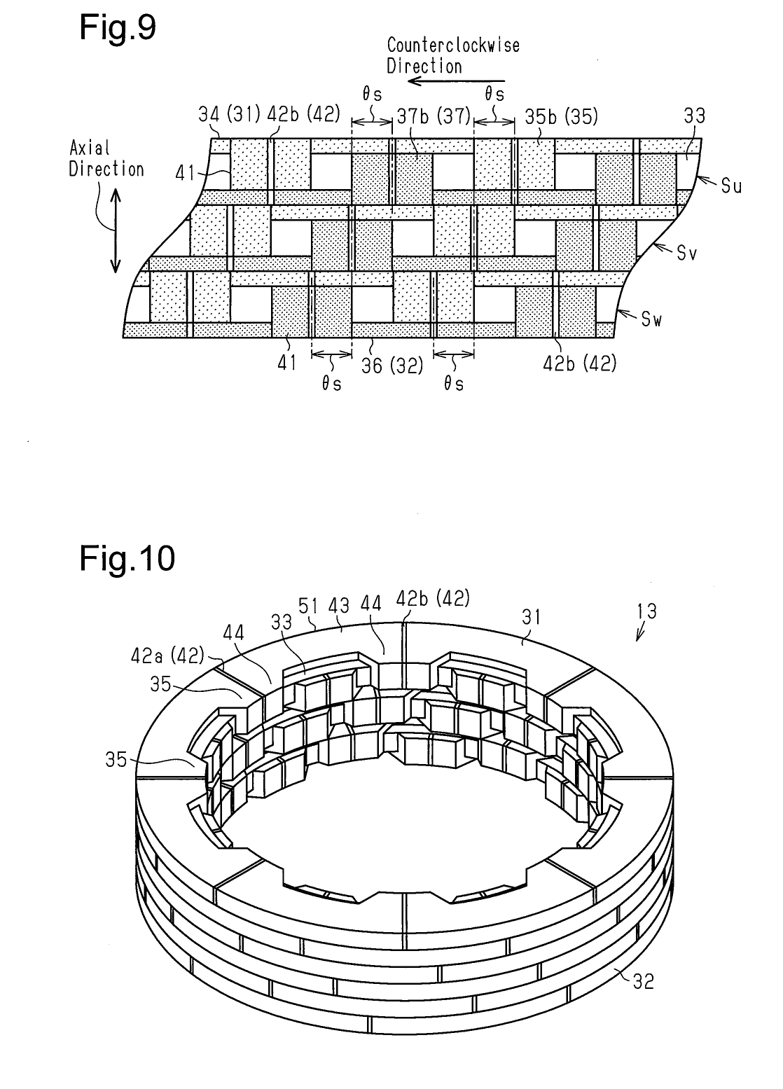

As shown in FIG. 9, the U-phase stator unit Su, the V-phase stator unit Sv, and the W-phase stator unit Sw are sequentially stacked in the axial direction to form the stator 13. The stator units Su, Sv, and Sw are stacked so that the first stator core bases 34 and the second stator core bases 36 are alternately arranged in the axial direction.

The stator units Su, Sv, and Sw are stacked by sequentially shifting the phases by the shaft angle θs. In detail, the phase shift angle θs is set to 60 degrees in electrical angle (mechanical angle of 7.5 degrees). The V-phase stator unit Sv is shifted by a phase of 60 degrees in electrical angle (7.5 degrees in mechanical angle) from the U-phase stator unit Su in the counterclockwise direction. Further, the W-phase stator unit Sw is shifted by a phase of 60 degrees in electrical angle (7.5 degrees in mechanical angle) from the V-phase stator unit Sv in the counterclockwise direction.

The shift direction (counterclockwise direction) from the U-phase stator unit Su to the W-phase stator unit Sw is opposite to the shift direction (clockwise direction) from the U-phase rotor unit Ru to the W-phase rotor unit Rw. In other words, the phases of the units in the rotor 12 are shifted in directions opposite to the phases of the units in the stator 13.

The operation of the present embodiment will now be described.

When 3-phase power voltage is applied to the stator 13, U-phase power voltage is applied to the winding 33 of the U-phase stator unit Su, V-phase power voltage is applied to the winding 33 of the V-phase stator unit Sv, and W-phase power voltage is applied to the winding 33 of the W-phase stator unit Sw. This generates a rotation field at the stator 13 that rotates and drives the rotor 12.

As described above, the stator cores 31 and 32 each include the core segments 41 in the circumferential direction. Thus, when pressing and punching out the core segments 41, which form the stator cores 31 and 32, out of a plate, the core segments 41 may be punched out with smaller gaps in between.

In each of the stator cores 31 and 32, the resin portions 42 are located between the core segments 41. The resin portions 42 break the magnetic circuit and limit the generation of eddy current, which would be generated when each stator core is an integral core.

The advantages of the present embodiment will now be described.

(1) The stator cores 31 and 32 include the core segments 41 that are arranged in the circumferential direction. A core segment 41 is smaller than an integral core. Thus, when punching out the core segments 41 from a plate, many core segments 41 may be formed by narrowing the gaps between the core segments 41. This allows core segments to be formed by reducing the gaps so that material is not wasted. As a result, the yield may be improved.

(2) The stator cores 31 and 32 are divided in the circumferential direction. This reduces eddy current as compared to when the stator cores 31 and 32 are formed integrally and are annular.

(3) Further, the resin portions 42 are arranged between the core segments 41 that form the stator cores 31 and 32. This further reduces eddy current. The resin portions 42 may also function as dampers that reduce vibration.

(4) The core segments 41 are separated between the claw poles 35, between the claw poles 37, at the circumferential center of each claw pole 35, and at the circumferential center of each claw pole 37. This avoids situations in which magnetism is biased and imbalanced.

The above embodiment may be modified as described below.

In the above embodiment, the stator cores are divided between adjacent claw poles 35, between adjacent claw poles 37, at the circumferential center of each claw pole 35, and at the circumferential center of each claw pole 37. The divided locations and the divided number may be changed. One such example will now be described.

As shown in FIG. 10, a stator core may be formed by core segments 51 divided at the circumferential center of each claw pole 35 and the circumferential center of each claw pole 37. More specifically, as shown in FIG. 10, each core segment 51 includes an arc 43 and extensions 44 extending from the two circumferential sides of the arc 43. The extension 44 at the first circumferential side of the core segment 51 is adjacent to the extension 44 at the second circumferential side of another core segment 51 with a resin portion 42 (first resin portion 42a) located in between. In other words, the core segment 51 is formed so that the extension 44 at the second circumferential side is adjacent to the extension 44 at the first circumferential side of another core segment 51 with a resin portion (first resin portion 42a) located in between. Such a structure also obtains advantages (1) to (4). Further, the core segments include only the core segments 51. That is, there is only one type of core segments. This facilitates the management of components.

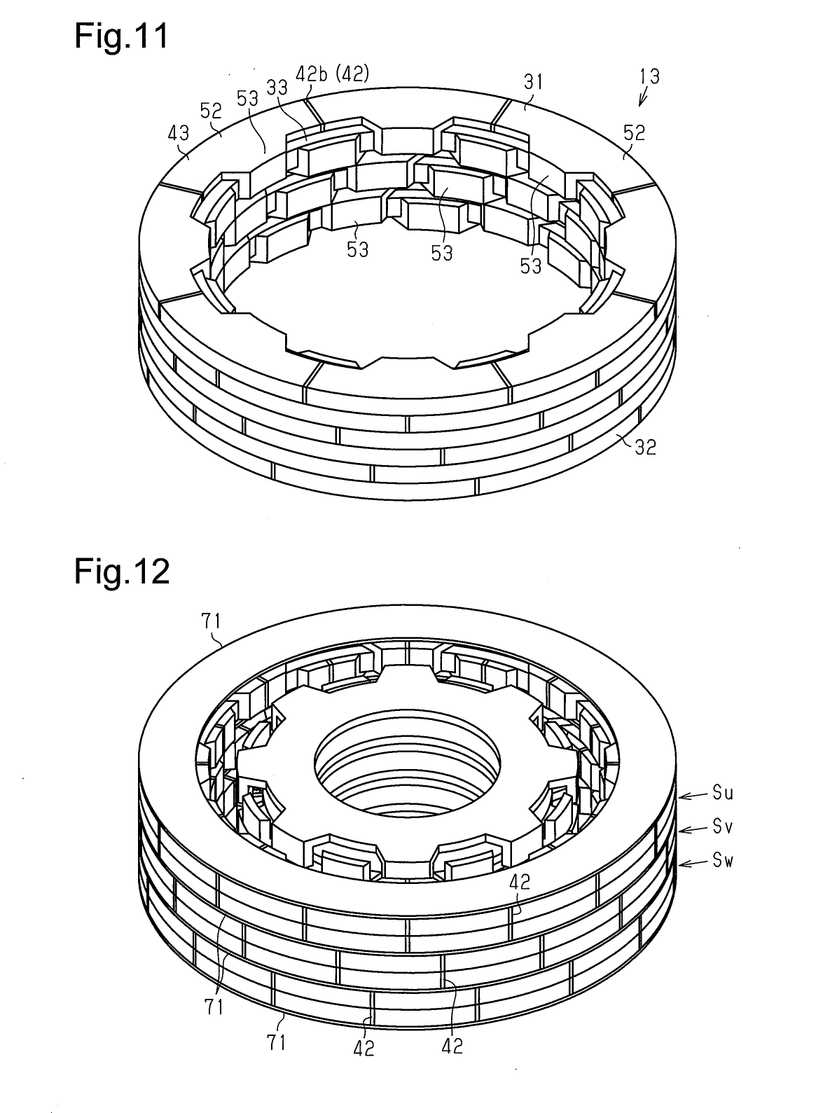

As shown in FIG. 11, a stator core may be formed by core segments 52 divided between the claw poles 35 and between the claw poles 37. More specifically, as shown in FIG. 11, each core segment 52 includes an arc 43 and an extension 53, which extends in the radial direction from the circumferentially central portion of the arc 43. The extension 53 of the present structure corresponds to the claw poles 35 and 37 of the above embodiment from which the first resin portions 42a are eliminated. Each core segment 52 is formed so that the first circumferential end of the arc 43 is adjacent to the second circumferential end of the arc 43 of another core segment 52. In other words, the second circumferential end of the arc 43 of the core segment 52 is adjacent to the first circumferential end of the arc 43 of another core segment 52 with a second resin portion 42b located in between. Such a structure also obtains advantages (1) to (4).

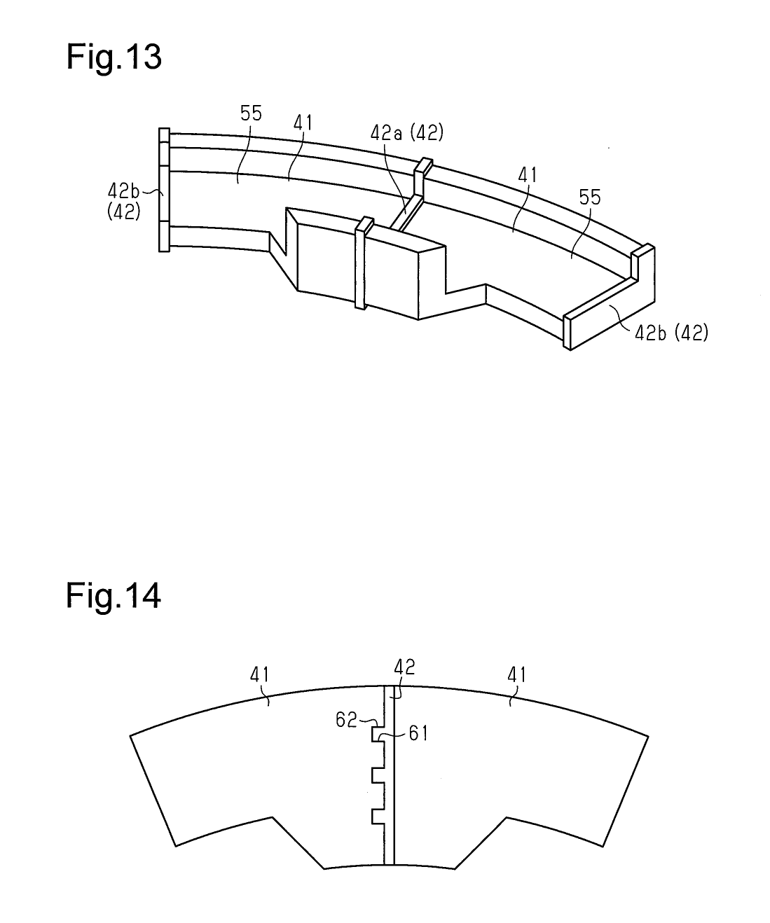

As shown in FIG. 13, the resin portion 42 is formed to project from an axial end surface 55 (axial surface) of the core segment 41. This structure limits contact of the end surface 55 (axial surface) of the core segment 41 with the winding 33 and contact of the end surface 55 (axial surface) of the core segment 41 with the magnet 23.

As shown in FIG. 14, the circumferential end surface (outer surface) of a core segment 41 includes core engagement portions 61 that are recessed in the circumferential direction. The resin portion 42 includes resin engagement portions 62 that engage the core engagement portions 61. This structure facilitates the engagement of the resin portion 42 and the core segment 41. Further, an anchor effect may be produced thereby limiting separation of the core segment 41 from the resin portion 42. In FIG. 14, the engagement portions 61 and 62 are not shown in scale and are actually smaller.

Although the method for fixing the core segment 41 has not been particularly described in the above embodiment, the core segments 41 may be, for example, fixed by an adhesive or the like to the housing. Further, the methods described below may also be performed.

As shown in FIG. 12, an annular resin portion 71 may be arranged at axially opposite sides of each of the stator units Su, Sy, and Sw, and the annular resin portions 71 may be formed integrally with the resin portion located between the core segments 41. This limits displacement of the core segments 41 in the axial direction and the circumferential direction.

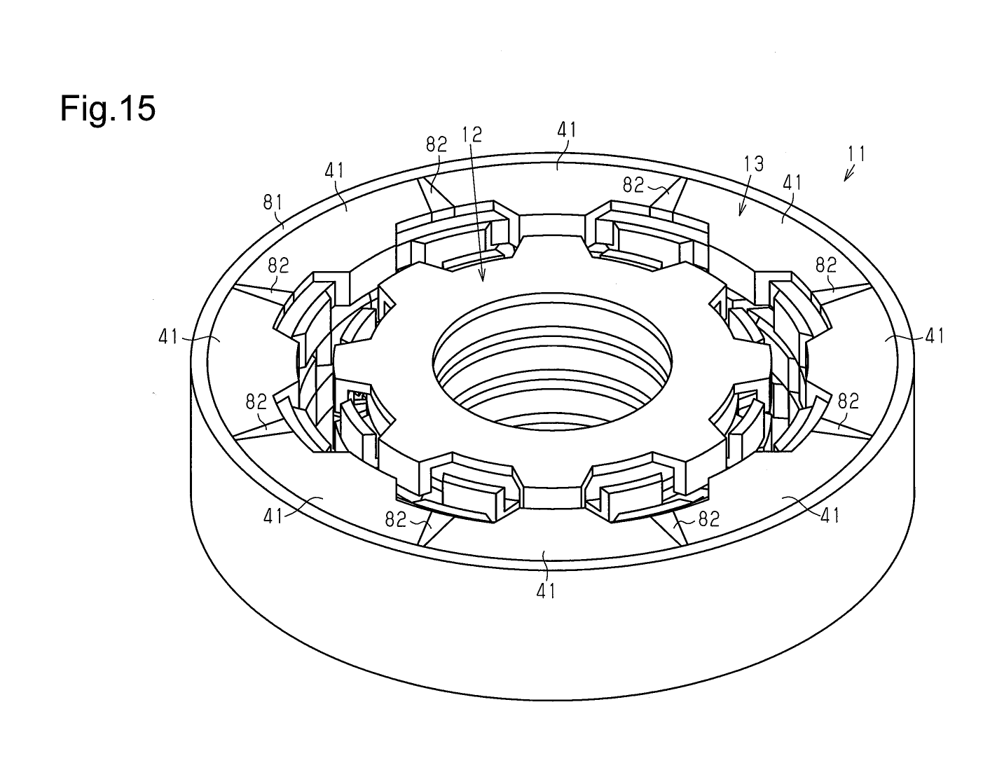

As shown in FIG. 15, core segments 41 may be arranged in a tubular housing 81, which serves as an annular member, and wedge-shaped resin portions 82 may be press-fitted between the core segments 41 from the radially inner side or the axially outer side. This fixes the core segments 41 to the tubular housing 81 located at the radially outer side. In this structure, the resin portions 82 are press-fitted between the core segments 41 to generate force that acts toward the radially outer side. The force allows the core segments 41 and the resin portions 82 to be fixed to the tubular housing 81. That is, the tubular housing 81 and the core segments 41 (outer core), which form the stator cores 31 and 32, may be integrated.

Each of the fixing methods described above may be combined with the use of an adhesive or the like.

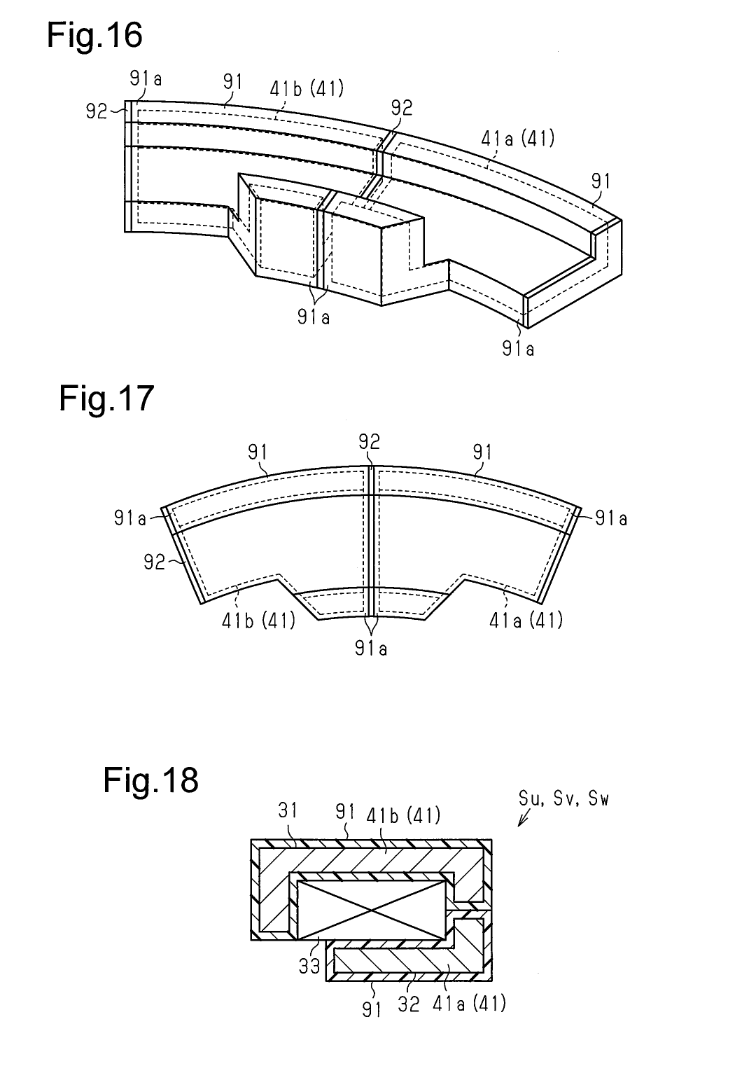

As shown in FIGS. 16 and 17, the entire surface (surrounding) of each of the core segments 41a and 41b may be coated with a resin. In detail, the entire surface (surrounding) of each of the core segments 41a and 41b may be covered by a resin coating 91. The resin coating 91 is formed to cover the surrounding of each of the core segments 41a and 41b. The first and second stator cores 31 and 32 may be formed by integrating the core segments 41a and 41b, which are covered by the resin coating 91, with an adhesive 92 into an annular form. Here, radial outer portions 91a, which are located between the core segments 41a and 41b of the resin coating 91, function as the resin portions 42. In FIGS. 16 and 17, the core segments 41a and 41b are shown by broken lines. Further, the resin coating 91, which covers the surrounding of the core segments 41a and 41b, and the adhesive 92, which adheres the core segments 41a and 41b (resin coating 91), are shown by solid lines.

Further, as shown in FIG. 18, the stator units Su, Sv, and Sw (only one unit shown in FIG. 18) are formed by coupling the first stator core 31 and the second stator core 32 to each other so that the winding 33 is arranged between the first stator core 31 and the second stator core 32 in the axial direction.

In such a structure, the resin coating 91 (radial outer portion 91a), which covers the entire surface (surrounding) of each of the core segments 41a and 41b, obtains the same advantages as the resin portions 42 of the above embodiment. Further, by covering the entire surface of each of the core segments 41a and 41b, contact of the winding 33 with the core segments 41a and 41b (stator cores 31 and 32) may be restricted. That is, the resin coating 91 functions as an insulation member. Thus, the core segments 41a and 41b (stator cores 31 and 32) may be insulated without arranging an insulator between the winding 33 and the core segments 41a and 41b (stator cores 31 and 32). This reduces the number of components.

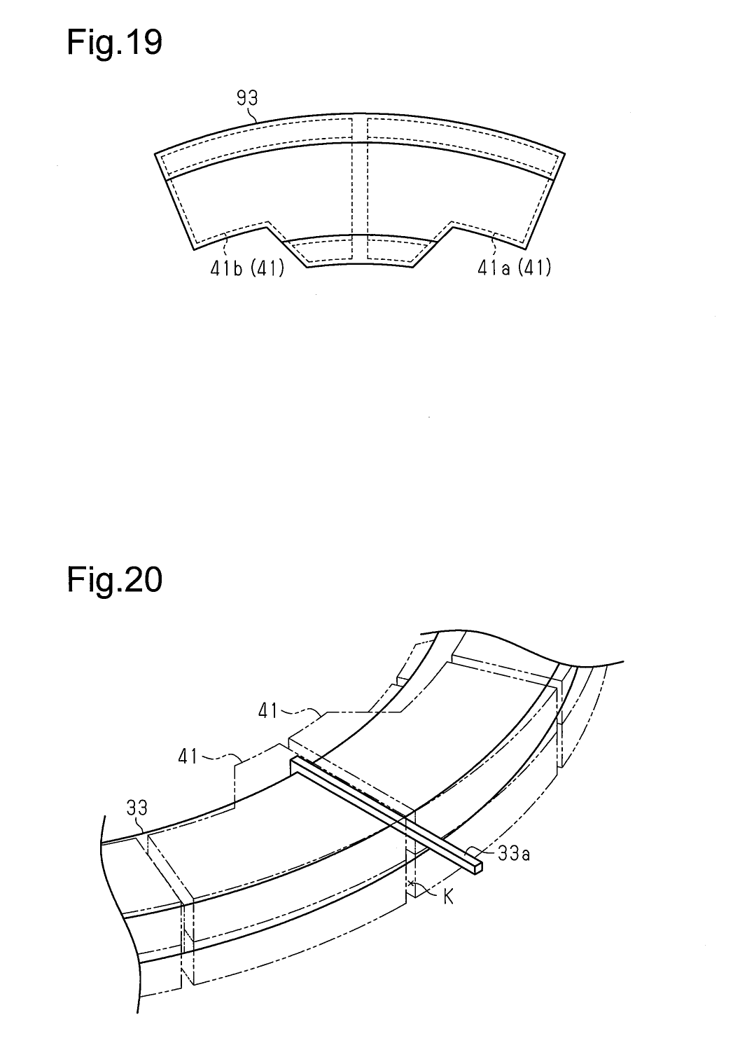

As shown in FIG. 19, the core segments 41a and 41b may be separated from one another and arranged in an annular shape, and resin molding portions 93 may be subjected to insert molding to entirely cover the surfaces of the core segments 41a and 41b. In this case, there is no need to coat the core segments 41a and 41b like in FIGS. 16 and 18. Thus, adhesion with the adhesive 92 (refer to FIGS. 16 and 17) is unnecessary. The first stator core 31 and the second stator core 32, which form each of the stator units Su, Sy, and Sw, may be integrated into a single component. This further reduces the number of components. Further, in the same manner as the structure shown in FIGS. 16 to 18, the resin molding portions 93, which are formed through insert-molding, obtains the same advantages as the resin portions 42 of the above embodiment.

In the above embodiment, only the stator cores 31 and 32 are formed by the core segments 41. However, for example, the rotor cores 21 and 22 may be formed by core segments, and the stator cores 31 and 32 and the rotor cores 21 and 22 may both be formed by core segments.

The resin portions 42 do not have to be arranged between the core segments 41 like in the above embodiment.

For example, as shown in FIG. 20, a gap K (space) between the core segments 41 in the circumferential direction may be used to draw out a terminal wire 33a (winding initiation wire or winding termination wire) of the winding 33. In such a structure, there is no need to provide space dedicated for the terminal wire 33a and used when drawing out the terminal wire 33a. Thus, space for the winding may be effectively used. The terminal wire 33a includes a conductor and an insulator, which covers the conductor. Thus, electric connection of the core segments 41 through the winding 33 (terminal wire 33a) is restricted. This reduces the generation of a large loop eddy current, which may be generated in a stator. Further, the flow of current to the core segments 41 is limited, and decreases in the current flowing to the generation are limited.

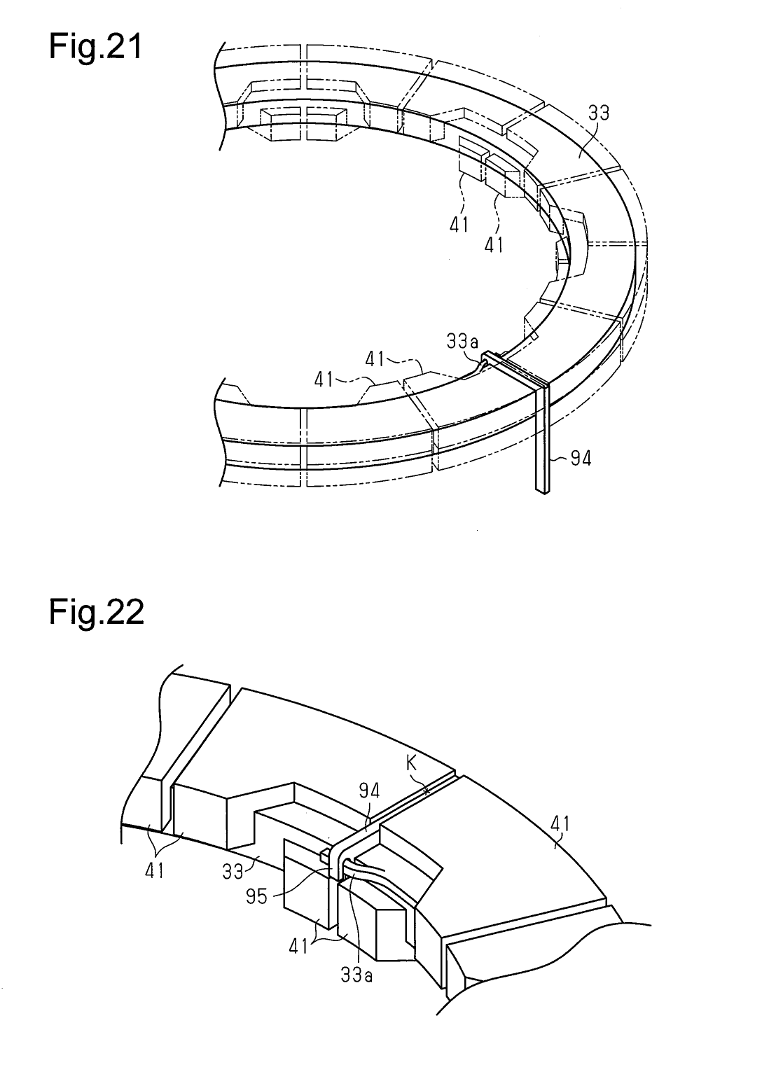

Further, as shown in FIGS. 21 and 22, the terminal wire 33a may be drawn out toward the radially inner side. A terminal 94, which is connected to the terminal wire 33a that is drawn out toward the radially inner side, may be arranged in a circumferential gap between core segments 41. The terminal 94 is a conductor. The terminal 94 may include an insulating member. The terminal 94 is generally L(U)-shaped and engaged with (connected to) the terminal wire 33a at a distal engagement portion 95. The engagement portion 95 is bifurcated, and the bifurcated part holds the terminal wire 33a. In such a structure, when the terminal 94 is provided, the terminal 94 may be arranged in the gap K, and space may be effectively used.

Although not particularly described in the above embodiment, for example, the winding 33 may be divided.

As shown in FIG. 24, the winding 33 includes conductor segments 96 and circuit sections 97, which are located between the conductor segments 96.

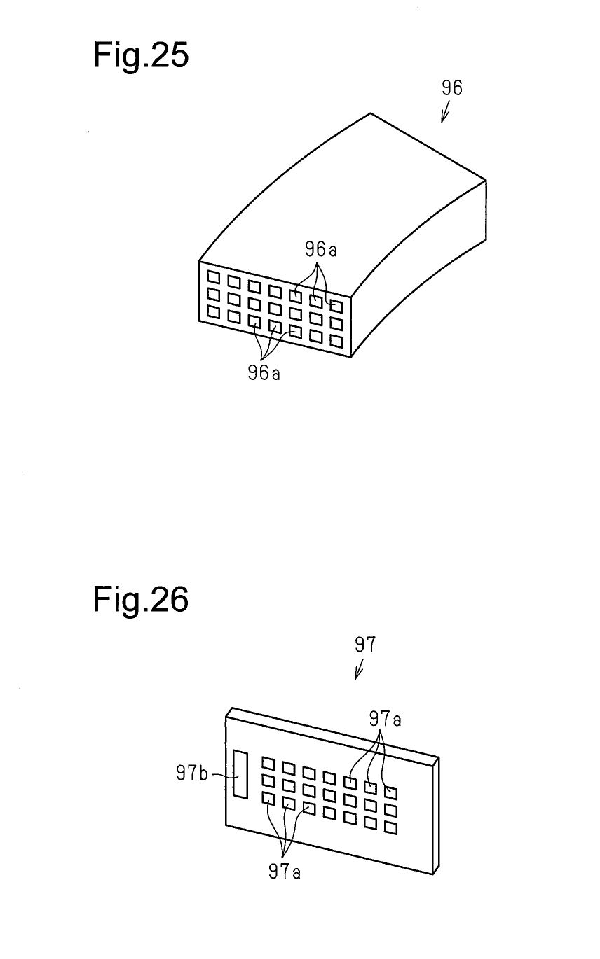

As shown in FIG. 25, each conductor segment 96 may be formed covering conductors 96a with an insulative material.

As shown in FIG. 26, the circuit section 97 includes conductive portions 97a, which are connected to the conductors 96a, and a control circuit 97b, which includes switching elements for activating and deactivating the conductive portions 97a. The control circuit 97b is connected to an external motor ECU by a wire (both not shown). The switching elements are activated and deactivated based on signals from the motor ECU.

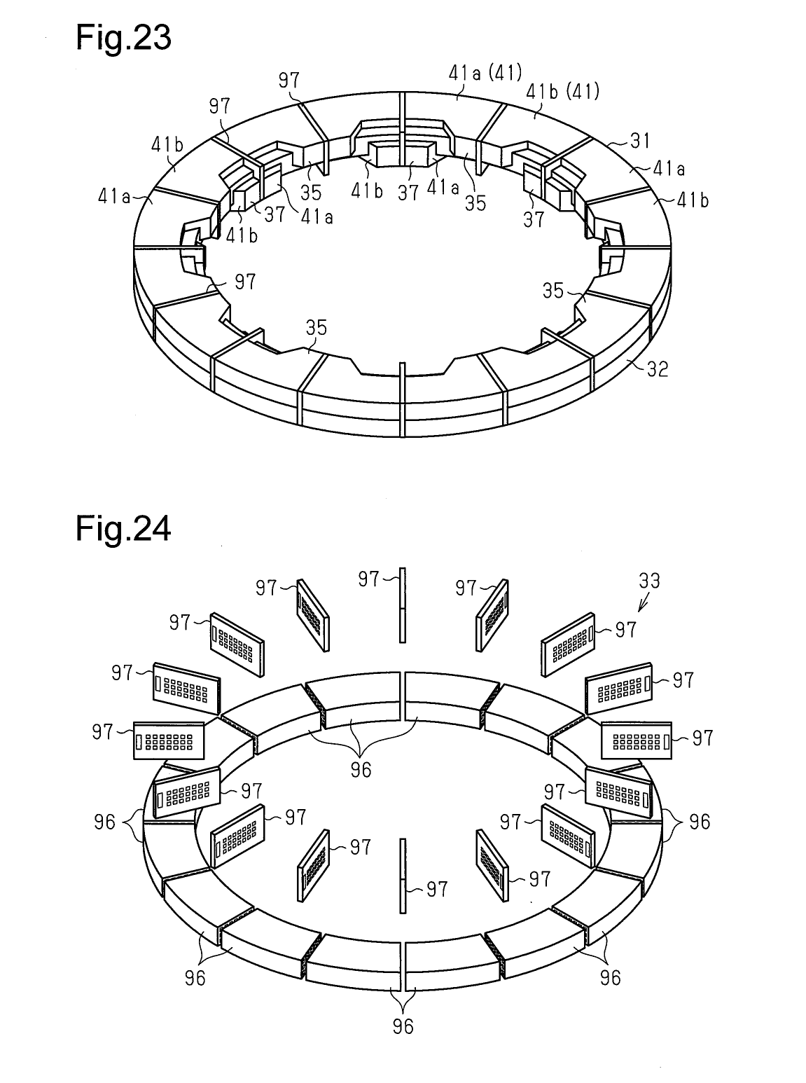

Further, as shown in FIG. 23, when coupling the winding 33 to the core segments 41, the circuit sections 97 of the winding 33 are arranged between the core segments 41. More specifically, the circuit sections 97 are located between the first circumferential sides of the first core segments 41a and the second circumferential sides of the second core segments 41b and between the second circumferential sides of the first core segments 41a and the first circumferential sides of the second core segments 41b. That is, the circuit sections 97 are arranged at the circumferential center of each claw pole 35, between the claw poles 35, at the circumferential center of each claw pole 37, and between the claw poles 37. The winding 33 is divided at the same positions as where the core segments 41 are separated. Thus, the winding 33 is arranged in a well-balanced manner. Further, the winding 33 (conductor segment 96) may be provided for each core segment 41. In this case, when the portion of contact between the circuit section 97 and the core segment 41 is formed from a resin material, the same advantages may be obtained as the resin portions 42 of the above embodiment.

In such a structure, the activation of each conductor segment 96 is controllable, and vibration may be reduced which would be caused by deformation (elastic deformation) in the radial direction of the stator 13. Further, by activating only some of the conductor segments 96, the flow of a large loop eddy current through the winding 33 is avoided, and the magnetic flux may be obtained.

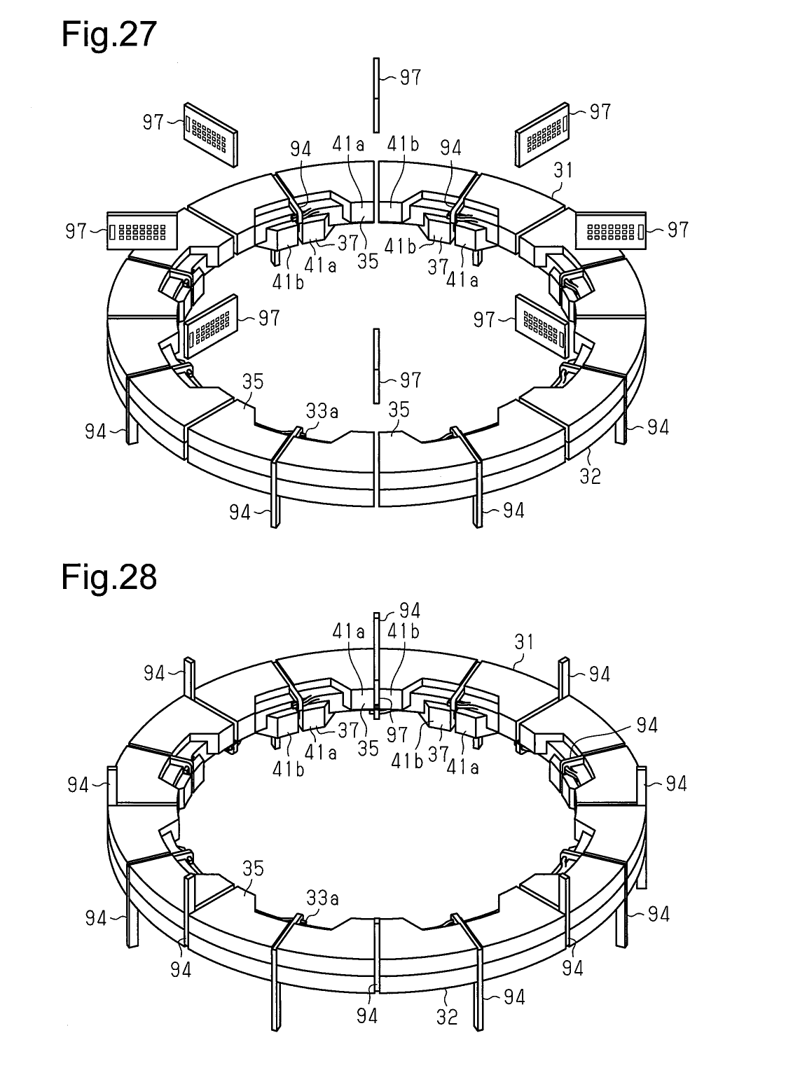

Further, as shown in FIG. 27, the terminals 94, which are connected to the terminal wire 33a, may be arranged between the claw poles 35, which are where the circumferential center of each claw pole 37 is located. Also, the circuit sections 97 may be arranged between the claw poles 37.

As shown in FIGS. 2B to 30, the terminals 94 and the circuit sections 97 may be arranged between the core segments 41, that is, at the circumferential center of each claw pole 35 (between claw poles 37) and at the circumferential center (between claw poles 35) of each claw pole 37.

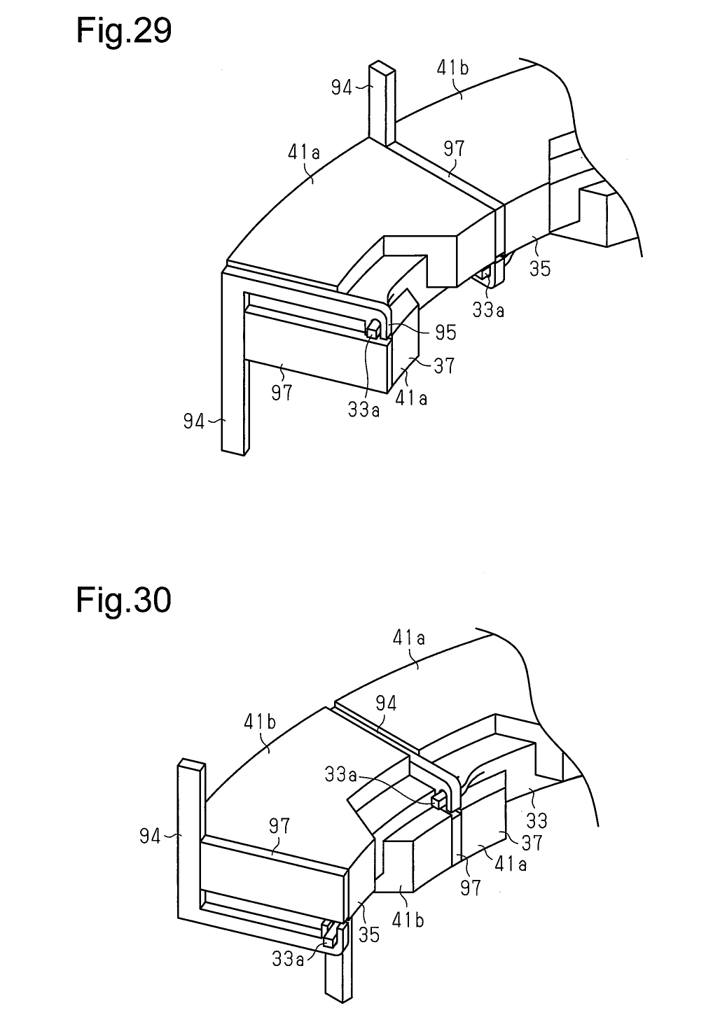

As shown in FIGS. 29 and 30, the engagement portions 95 of the terminals 94 arranged between the claw poles 35, which are where the circumferential center of each claw pole 37 is located, are located at a first axial side (upper side as viewed in the drawing) of the circuit sections 97. Further, the engagement portions 95 of the terminals 94 arranged between the claw poles 37, which are where the circumferential center of each claw pole 35 is located, are located at a second axial side (lower side as viewed in the drawing) of the circuit sections 97.

In the above embodiment, the field magnet 23 is a ferrite magnet but may also be, for example, a samarium-cobalt (SmCo) magnet or a neodymium magnet.

The numbers of the claw poles 25, 27, 35, and 37 (magnet numbers) are not limited to numbers in the above embodiment and may be changed in accordance with the structure.

The numbers of the rotor units Ru, Rv, and Rw forming the rotor 12 and the numbers of the stator units Su, Sv, and Sw forming the stator 13 are not limited to the numbers in the above embodiment and may be changed in accordance with the structure.

In the above embodiment, the present invention is applied to an inner rotor motor in which the rotor 12 is arranged at the inner side of the stator 13. However, the present invention may be applied to an outer rotor motor.

A second embodiment of a multi-Lundell motor will now be described.

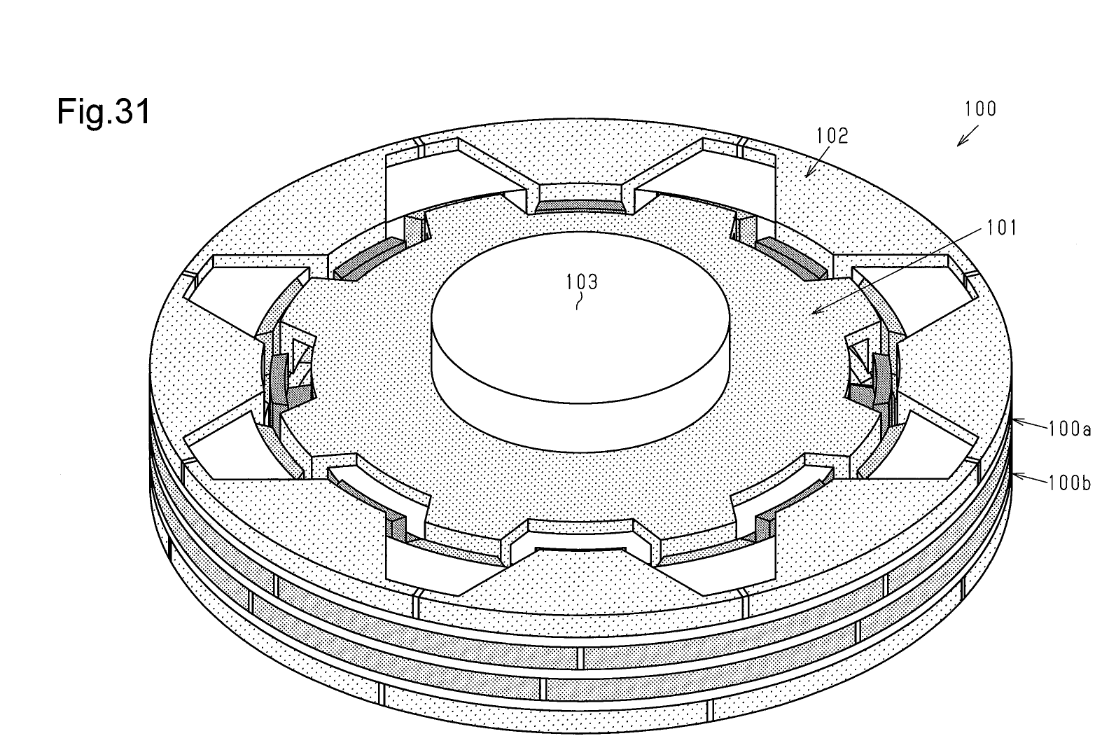

As shown in FIG. 31, in the present embodiment, a motor 100 includes a rotor 101 and a stator 102, which is arranged at the radially outer side of the rotor 101.

Further, as shown in FIG. 31, the motor 100 includes a multi-Lundell A-phase motor unit 100a and a multi-Lundell B-phase motor 100b that are stacked one above the other with the A-phase motor unit 100a located at the upper side. Thus, the motor 100 is a two-layer, two-phase multi-Lundell motor. The A-phase motor unit 100a and the B-phase motor unit 100b each form a single multi-Lundell motor.

Rotor

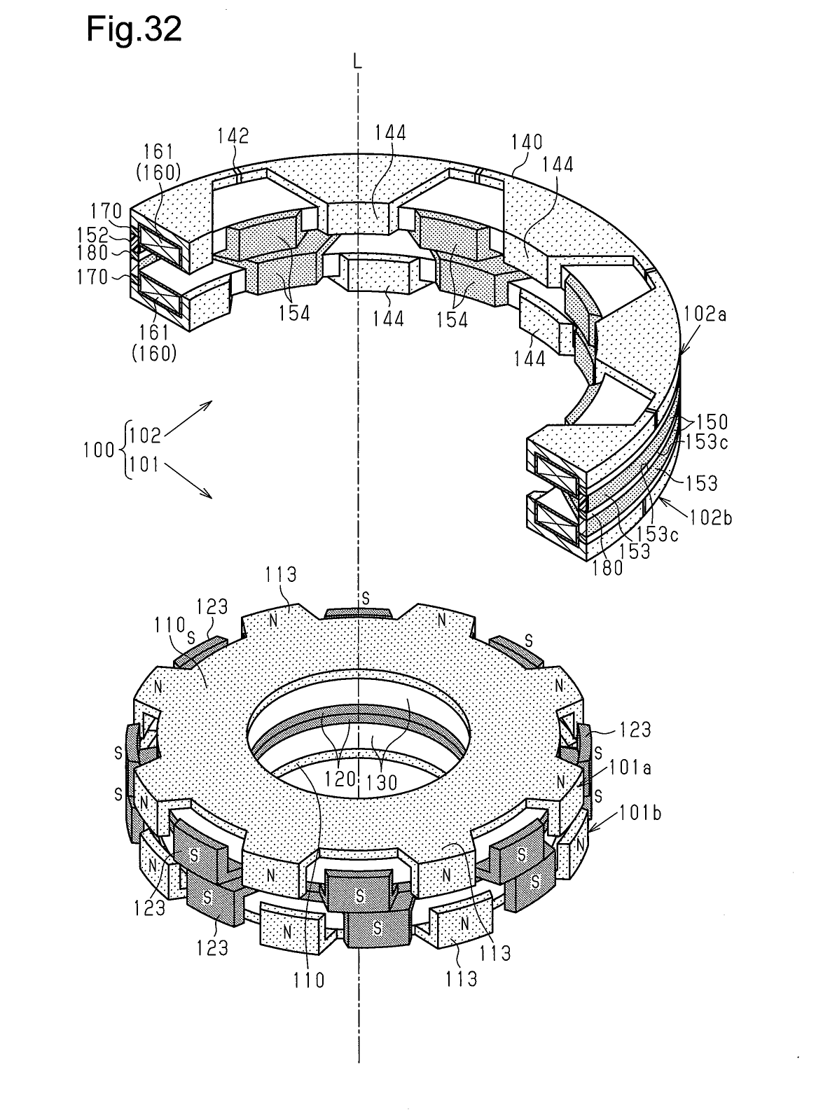

As shown in FIGS. 31 and 32, the rotor 101 of the motor 100 includes a rotation shaft 103, an A-phase rotor unit 101a, and a B-phase rotor unit 101b. The A-phase rotor unit 101a and the B-phase rotor unit 101b, which are fitted and fixed to the rotation shaft 103, are substantially identical in structure and shape. Further, the A-phase rotor unit 101a and the B-phase rotor unit 101b are substantially annular as a whole and arranged (stacked) in the axial direction of the rotation shaft 103.

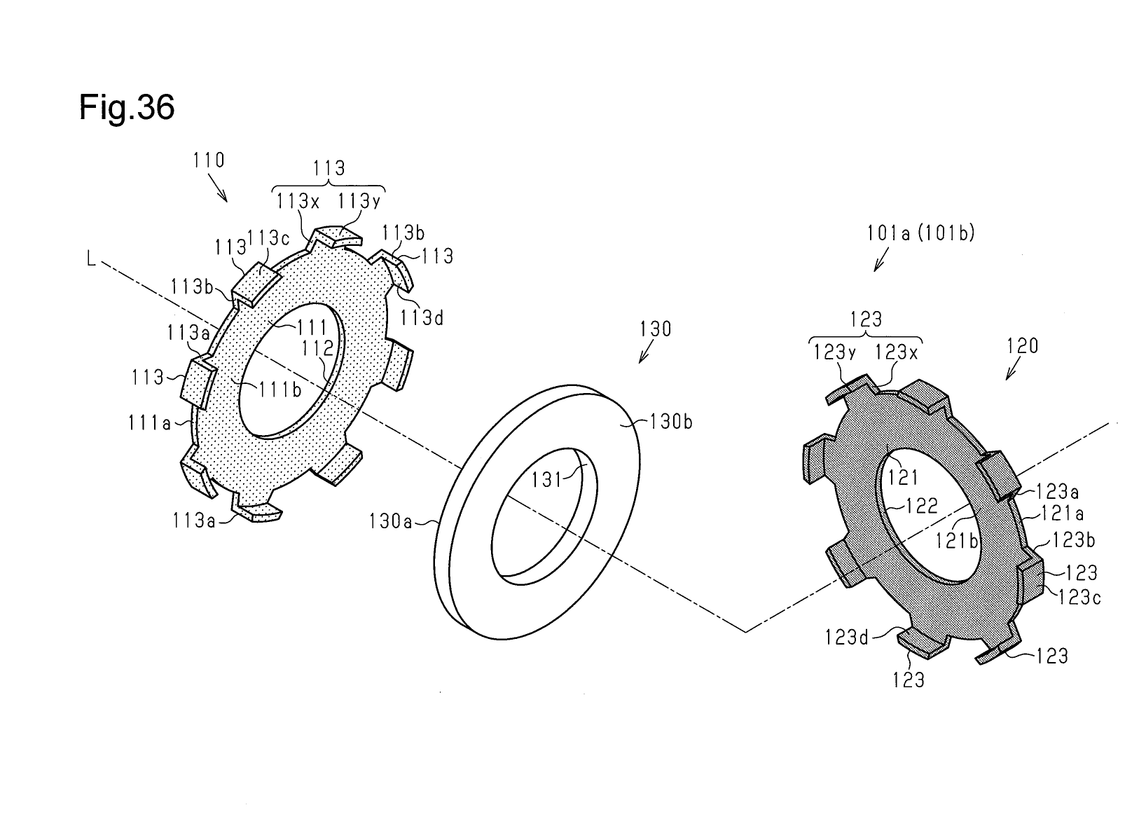

As shown in FIG. 36, the A-phase rotor unit 101a and the B-phase rotor unit 101b each include a first rotor core 110, a second rotor core 120, and an annular magnet 130.

First Rotor Core

As shown in FIG. 36, the first rotor core 110 includes a first rotor core base 111, which is formed by an annular electromagnetic steel plate. An insertion hole 112 extends through a central portion of the first rotor core base 111 for insertion of a rotation shaft 103 (refer to FIG. 31).

Eight first rotor claw poles 113, which are substantially identical in shape, are formed at equal intervals (45-degree intervals) in the circumferential direction on the outer circumferential surface 111a of the first rotor core base 111. Each first rotor claw pole 113 projects from the first rotor core base 111 toward the outer side in the radial direction. The distal end of the first rotor claw pole 113 is bent in the axial direction toward the second rotor core 120.

In the first rotor claw pole 113, the portion projected radially outward from the outer circumferential surface 111a of the first rotor core base 111 is referred to as a first rotor basal portion 113x, and the distal portion bent in the axial direction is referred to as a first rotor pole portion 113y. The first rotor basal portion 113x is trapezoidal and narrowed toward the outer side in the radial direction as viewed in the axial direction. The first rotor pole portion 113y is formed to be tetragonal as viewed in the radial direction. Further, the circumferential end surfaces 113a and 113b of the first rotor claw pole 113, which includes the first rotor basal portion 113x and the first rotor pole portion 113y, are both flat surfaces.

The first rotor pole portion 113y, which is bent in the axial direction, has a sectorial cross-section in a direction orthogonal to the axis. The first rotor pole portion 113y includes a radially outer surface 113c and a radially inner surface 113d, which are arc surfaces and extend about the axis L. The radially outer surface 113c and the radially inner surface 113d are concentric with the outer circumferential surface 111a of the first rotor core base 111.

Second Rotor Core

As shown in FIG. 36, the second rotor core 120 includes an annular second rotor core base 121, which is formed from the same material as the first rotor core 110 and has the same shape as the first rotor core 110. An insertion hole 122 extends through a central portion of the second rotor core base 121. The rotation shaft 103 is inserted through and fixed in the insertion hole 122.

Eight second rotor claw poles 123, which are substantially identical in shape, are formed at equal intervals (45-degree intervals) in the circumferential direction on the outer circumferential surface 121a of the second rotor core base 121. Each second rotor claw pole 123 projects from the second rotor core base 121 toward the outer side in the radial direction. The distal end of the second rotor claw pole 123 is bent in the axial direction toward the first rotor core 110.

In the second rotor claw pole 123, the portion projected radially outward from the outer circumferential surface 121a of the second rotor core base 121 is referred to as a second rotor basal portion 123x, and the distal portion bent in the axial direction is referred to as a second rotor pole portion 123y. The second rotor basal portion 123x is trapezoidal and narrowed toward the outer side in the radial direction as viewed in the axial direction. The second rotor pole portion 123y is formed to be tetragonal as viewed in the radial direction. Further, the circumferential end surfaces 123a and 123b of the second rotor claw pole 123, which includes the second rotor basal portion 123x and the second rotor pole portion 123y, are both flat surfaces.

The second rotor pole portion 123y, which is bent in the axial direction, has a sectorial cross-section in a direction orthogonal to the axis. The second rotor pole portion 123y includes a radially outer surface 123c and a radially inner surface 123d, which are arc surfaces and extend about the axis L. The radially outer surface 123c and the radially inner surface 123d are concentric with the outer circumferential surface 121a of the second rotor core base 121.

The circumferential angle over which the second rotor basal portion 123x of each second rotor claw pole 123 extends, that is, the angle between the basal portions of the circumferential end surfaces 123a and 123b relative to the axis L, is smaller than the angle of the gap extending between adjacent ones of the second rotor claw poles 123.

The second rotor core 120 is positioned relative to the first rotor core 110 so that the second rotor claw poles 123 are located between the first rotor claw poles 113 of the first rotor core 110 as viewed in the direction of the axis. The second rotor core 120 is coupled to the first rotor core 110 so that the annular magnet 130 is arranged between the first rotor core 110 and the second rotor core 120 in the axial direction.

Annular Magnet 130

In the present embodiment, the annular magnet 130 is an annular flat permanent magnet formed by, for example, a ferrite sintered magnet.

As shown in FIG. 36, an insertion hole 131 extends through the central portion of the annular magnet 130. The rotation shaft 103 (refer to FIG. 31) is inserted through the insertion hole 131. The annular magnet 130 is held and fixed between the first rotor core 110 and the second rotor core 120. One axial end surface 130a of the annular magnet 130 is in contact with an opposing surface 111b of the first rotor core base 111. The other axial end surface 130b of the annular magnet 130 is in contact with an opposing surface 121b of the second rotor core base 121. The annular magnet 130 has an outer diameter that conforms to that of the first rotor core base 111 and the second rotor base 121. Further, the annular magnet 130 has a thickness that is set in advance.

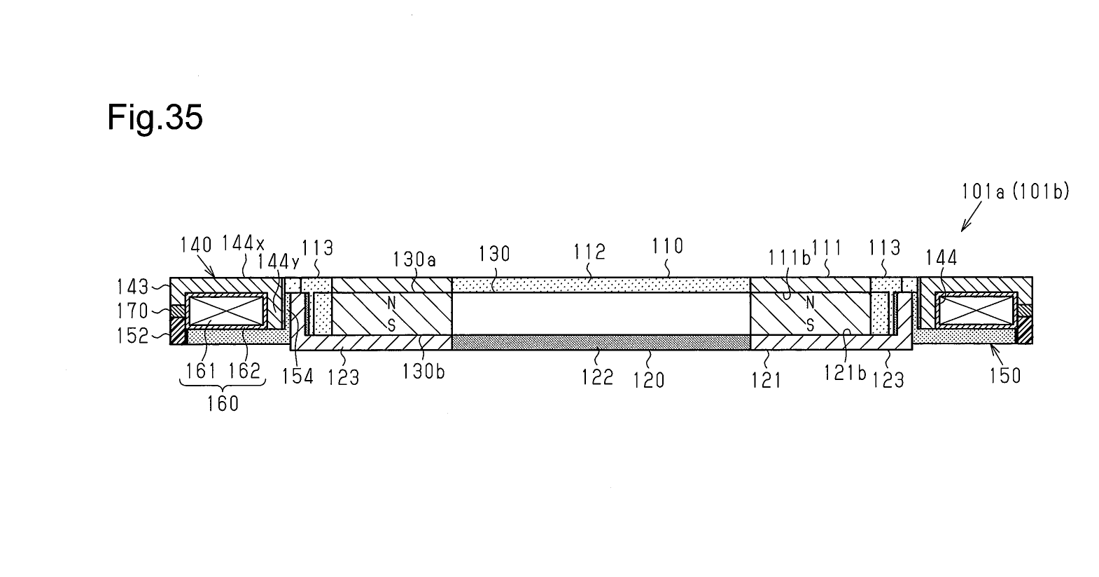

As shown in FIG. 35, the annular magnet 130 is magnetized in the axial direction so that the portion closer to the first rotor core 110 is the N pole and the portion closer to the second rotor core 120 is the S pole. Accordingly, due to the annular magnet 130, each first rotor claw pole 113 of the first rotor core 110 functions as the N pole, and each second rotor claw pole 123 of the second rotor core 120 functions as the S pole.

The A-phase rotor unit 101a and the B-phase rotor unit 101b are each formed as a rotor unit having a Lundell structure that uses the annular magnet 130. The A-phase rotor unit 101a and the B-phase rotor unit 101b form a rotor including sixteen poles (eight pole pairs) with the first rotor claw poles 113, which become the N-poles, and the second rotor claw poles 123, which become the S-poles, being alternately arranged in the circumferential direction.

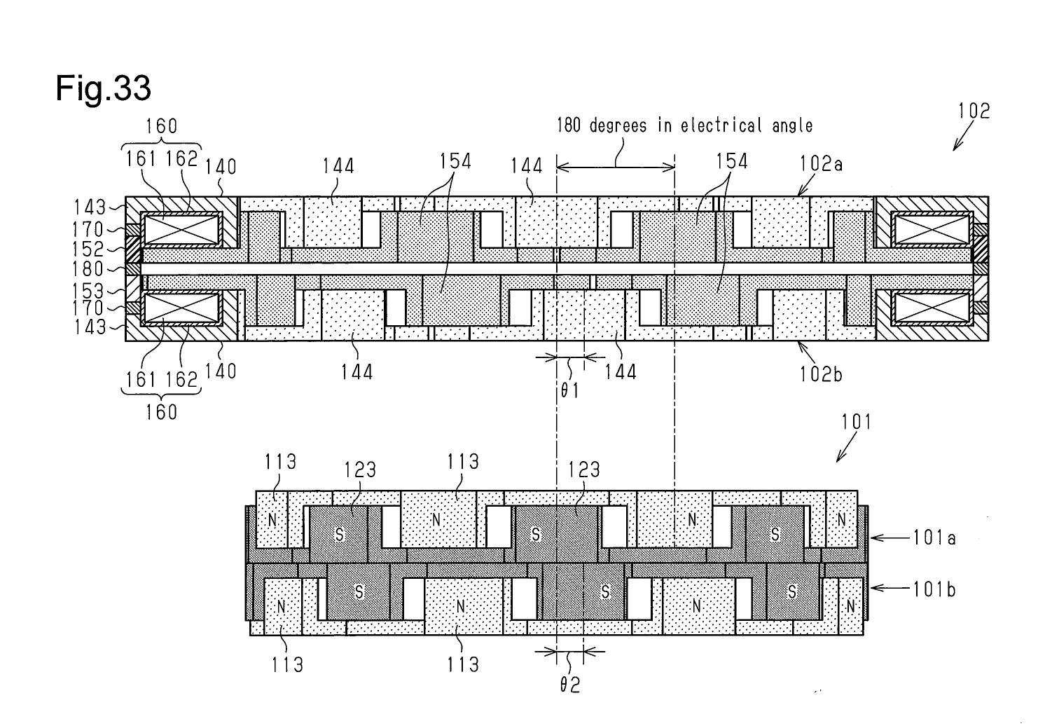

As shown in FIGS. 32 and 33, the A-phase rotor unit 101a and the B-phase rotor unit 101b are stacked in the axial direction to form a two-phase Lundell rotor 101. The A-phase rotor unit 101a and the B-phase rotor unit 101b are stacked in the axial direction as described below.

The A-phase rotor unit 101a and the B-phase rotor unit 101b are stacked so that the second rotor core 120 of the A-phase rotor unit 101a contacts the second rotor core 120 of the B-phase rotor unit 101b.

As shown in FIG. 33, the A-phase rotor unit 101a and the B-phase rotor unit 101b are stacked with the B-phase rotor unit 101b shifted from the B-phase rotor unit 101b by a predetermined angle in the counterclockwise direction as viewed in the axial direction. In detail, the second rotor claw poles 123 (first rotor claw poles 113) of the B-phase rotor unit 101b are shifted by a predetermined electrical angle θ2 in the counterclockwise direction from the second rotor claw poles 123 (first rotor claw poles 113) of the opposing A-phase rotor unit 101a.

Stator 102

As shown in FIG. 32, the stator 102 is arranged at the radially outer side of the rotor 101. The stator 102 is a stator having a two-phase structure. The stator 102 includes an A-phase stator unit 102a and a B-phase stator unit 102b, which are arranged (stacked) in the axial direction and both have a Lundell structure. The A-phase stator unit 102a and the B-phase stator unit 102b are sequentially stacked in the direction of the axis L opposing the corresponding A-phase rotor unit 101a and the B-phase rotor unit 101b, which are located at the radially inner side.

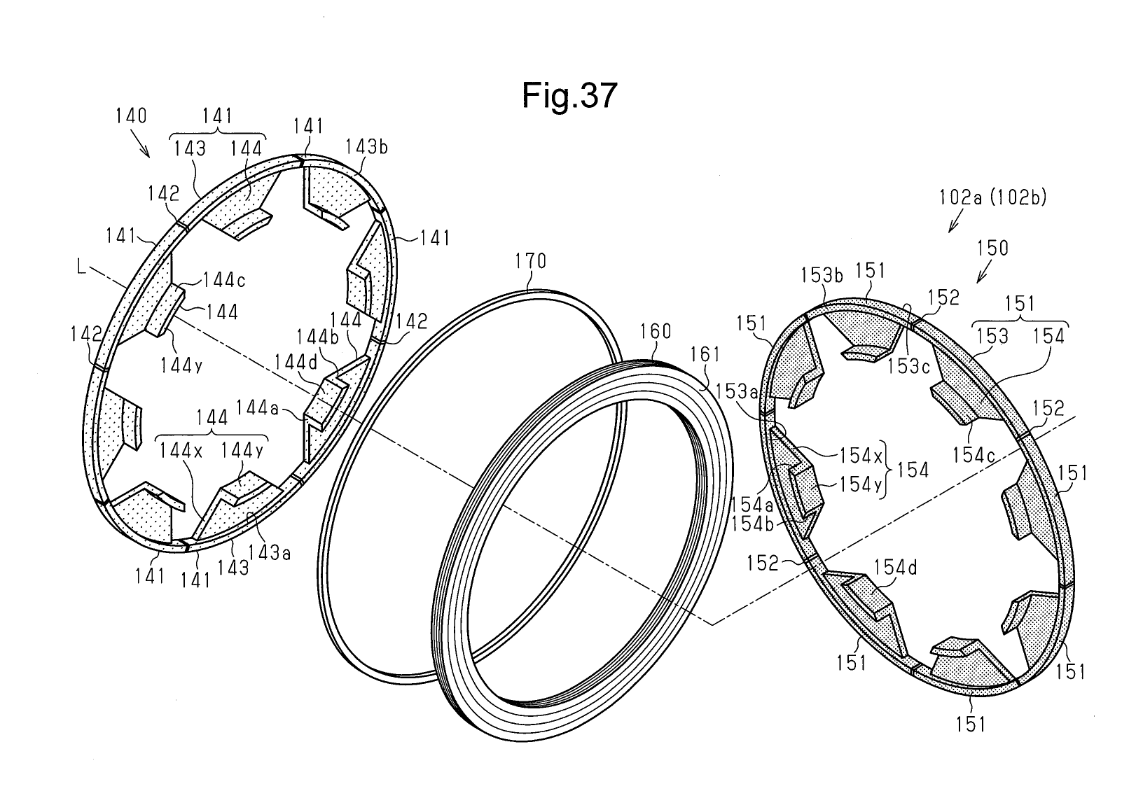

As shown in FIG. 37, the A-phase stator unit 102a and the B-phase stator unit 102b are identical in structure and each include a first stator core 140, a second stator core 150, and a coil 160.

First Stator Core 140

As shown in FIG. 37, the first stator core 140 includes a plurality of (eight in the present embodiment) core segments 141 and resin portions 142, which are arranged between the core segments 141. The first stator core 140 is formed to be generally annular by alternately arranging and fixing the core segments 141 and the resin portions 142 in the circumferential direction.

Each core segment 141 includes an arc wall portion 143 and a first stator claw pole 144. Each arc wall portion 143 has a predetermined length in the direction of the axis L and is arcuate as viewed in the direction of the axis L. A single first stator claw pole 144 is formed on a radially inner surface 143a of each arc wall portion 143 at a circumferentially central part of the arc wall portion 143. In other words, each of the eight arc wall portions 143 includes a first stator claw pole 144. Thus, each first stator core 140 includes eight first stator claw poles 144. Each first stator claw pole 144 projects from the arc wall portion 143 toward the inner side in the radial direction. The distal end of the first stator claw pole 144 is bent toward the second stator core 150 in the axial direction.

In the first stator claw pole 144, the portion projected radially inward from the radially inner surface 143a of the arc wall portion 143 is referred to as a first stator basal portion 144x, and the distal portion bent in the axial direction is referred to as a first stator pole portion 144y. The first stator basal portion 144x is trapezoidal and narrowed toward the inner side in the radial direction as viewed in the axial direction. The first stator pole portion 144y is formed to be tetragonal as viewed in the radial direction. Further, the circumferential end surfaces 144a and 144b of the first stator claw pole 144, which includes the first stator basal portion 144x and the first stator pole portion 144y, are both flat surfaces.

The first stator pole portion 144y, which is bent in the axial direction, has a sectorial cross-section in a direction orthogonal to the axis. The first stator pole portion 144y includes a radially outer surface 144c and a radially inner surface 144d, which are arc surfaces and extend about the axis L. The radially outer surface 144c and the radially inner surface 144d are concentric with the radially inner surface 143a of the arc wall portion 143.

The circumferential angle over which the first stator basal portion 144X of each first stator claw pole 144 extends, that is, the angle between the basal portions of the circumferential end surfaces 144a and 144b relative to the axis L, is smaller than the angle of the gap extending between adjacent ones of the first stator claw poles 144.

The resin portions 142 are non-magnetic bodies and arranged between the core segments 141. Each resin portion 142 includes end surfaces having substantially the same shape as the circumferential end surfaces of the arc wall portions 143 of the core segments 141 that the resin portion 142 contacts.

Second Stator Core 150

As shown in FIG. 37, the second stator core 150, which is formed from the same material and has the same shape as the first stator core 140, includes a plurality of (eight in the present embodiment) core segments 151 and resin portions 152, which are arranged between the core segments 151. The second stator core 150 is formed to be generally annular by alternately arranging and fixing the core segments 151 and the resin portions 152 in the circumferential direction.

Each core segment 151 includes an arc wall portion 153 and a second stator claw pole 154. Each arc wall portion 153 has a predetermined length in the direction of the axis L and is arcuate as viewed in the direction of the axis L. A single second stator claw pole 154 is formed on a radially inner surface 153a of each arc wall portion 153 at a circumferentially central part of the arc wall portion 153. In other words, each of the eight arc wall portions 153 includes a second stator claw pole 154. Thus, each second stator core 150 includes eight second stator claw poles 154.

Each second stator claw pole 154 projects from the arc wall portion 143 toward the inner side in the radial direction. The distal end of the second stator claw pole 154 is bent toward the first stator core 140 in the axial direction.

In the second stator claw pole 154, the portion projected radially inward from the radially inner surface 153a of the arc wall portion 153 is referred to as a second stator basal portion 154x, and the distal portion bent in the axial direction is referred to as a second stator pole portion 154y. The second stator basal portion 154x is trapezoidal and narrowed toward the inner side in the radial direction as viewed in the axial direction. The second stator pole portion 154y is formed to be tetragonal as viewed in the radial direction. Further, the circumferential end surfaces 154a and 154b of the second stator claw pole 154, which includes the second stator basal portion 154x and the second stator pole portion 154y, are both flat surfaces.

The second stator pole portion 154y, which is bent in the axial direction, has a sectorial cross-section in a direction orthogonal to the axis. The second stator pole portion 154y includes a radially outer surface 154c and a radially inner surface 154d, which are arc surfaces and extend about the axis L. The radially outer surface 154c and the radially inner surface 154d are concentric with the radially inner surface 153a of the arc wall portion 153.

The circumferential angle over which the second stator basal portion 154x of each second stator claw pole 154 extends, that is, the angle between the basal portions of the circumferential end surfaces 154a and 154b relative to the axis L, is smaller than the angle of the gap extending between adjacent ones of the second stator claw poles 154.

The resin portions 152 are non-magnetic bodies and arranged between the core segments 151. Each resin portion 152 includes end surfaces having substantially the same shape as the circumferential end surfaces of the arc wall portions 153 of the core segments 151 that the resin portion 152 contacts.

Coil 160

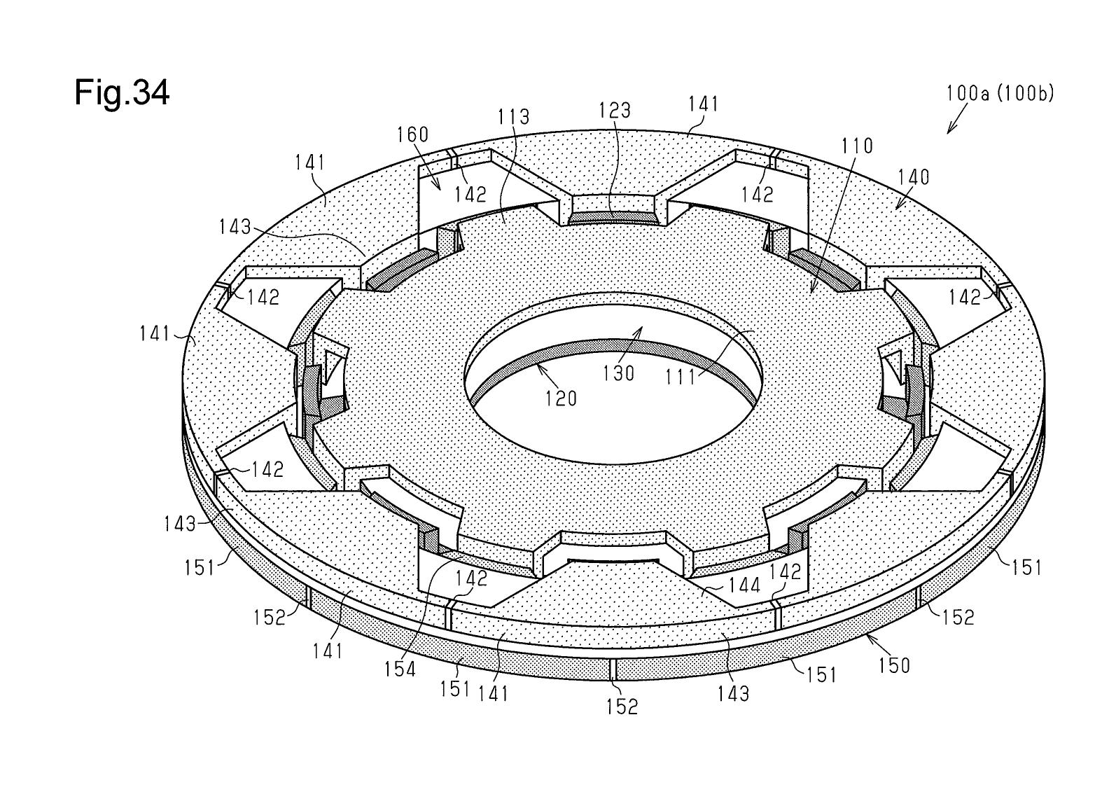

As shown in FIGS. 34 and 35, the coil 160 is arranged between the first stator core 140 and the second stator core 150.

As shown in FIGS. 35 and 37, the coil 160 includes an annular windings 161 wound in the circumferential direction. The annular windings 161 are surrounded by and covered by a coil insulation layer 162, which is formed by a resin mold. For the sake of brevity, the coil insulation layer 162 is not shown in FIG. 37.

As shown in FIG. 35, the coil 160 contacts the first stator basal portions 144X and the second stator basal portions 154x.

The coil 160 has a predetermined thickness (axial length) that is set in accordance with the axial length of the first stator claw pole 144 (second stator claw pole 154).

First Spacer 170

As shown in FIG. 37, in the present embodiment, the A-phase stator unit 102a and the B-phase stator unit 102b each include a first spacer 170.

As shown in FIG. 37, the first spacer 170 is annular and located between an axial end surface 143b (one of the end surfaces in the direction of axis L1) of each of the arc wall portions 143 and an axial end surface 153b (the other end surface in the direction of axis L1) of each of the arc wall portions 153. Further, the first spacer 170 contacts the axial end surfaces 143b and 153b and the resin portions 142 and 152.

The first spacer 170 is formed by, for example, a magnetic adhesive that is an adhesive agent including magnetic bodies. The first spacer 170 has a lower rigidity than the first stator core 140 and the second stator core 150 and easily deforms at least when coupling the first stator core 140 and the second stator core 150. The first spacer 170 is applied to (arranged between) the axial end surfaces 143b and 153b when coupling the first stator core 140, the second stator core 150, and the coil 160. The axial end surfaces 143b and 153b apply pressure to the first spacer 170 and deform the first spacer 170. This minimizes the gaps between the first spacer 170 and the axial end surfaces 143b and 153b so that the first spacer 170 contacts the axial end surfaces 143b and 153b.

Second Spacer 180

As shown in FIG. 32, the stator 102 of the present embodiment includes a second spacer 180 located between the A-phase stator unit 102a and the B-phase stator unit 102b in the axial direction.

The second spacer 180 is annular and located between an axial end surface 153c of each of the arc wall portions 153 in the A-phase stator unit 102a and an axial end surface 153c of each of the arc wall portions 153 in the B-phase stator unit 102b. The second spacer 180 is formed from, for example, a resin. The second spacer 180 contacts the resin portions 152, which are located between the arc wall portions 153 in the circumferential direction. Thus, the A-phase stator unit 102a and the B-phase stator unit 102b are separated and do not contact each other.

The A-phase stator unit 102a and the B-phase stator unit 102b each form a stator unit having a Lundell structure. In detail, the A-phase stator unit 102a and the B-phase stator unit 102b each form a stator having a 16-pole Lundell (claw pole) structure that has the first and second stator claw poles 144 and 154 excited to different poles by the annular windings 161 between the first and second stator cores 140 and 150.

As shown in FIGS. 32 and 33, the A-phase stator unit 102a and the B-phase stator unit 102b are arranged next to each other in the axial direction to form the two-phase Lundell stator 102.

As shown in FIG. 33, the A-phase stator unit 102a and the B-phase stator unit 102b are stacked so that the B-phase stator unit 102b is shifted from the A-phase stator unit 102a by a predetermined angle in the clockwise direction as viewed in the direction of the axis L.

In detail, the first stator claw poles 144 (second stator claw poles 154) of the B-phase stator unit 102b are shifted from the first stator claw poles 144 (second stator claw poles 154) of the opposing A-phase stator unit 102a by a predetermined electrical angle θ1 in the clockwise direction.

As viewed in the direction of the axis L, the electrical angle θ1 of the B-phase stator unit 102b relative to the A-phase stator unit 102a in the clockwise direction and the electrical angle θ2 of the B-phase stator unit 102b relative to the A-phase stator unit 102a in the counterclockwise direction are set to satisfy the relational equation shown below.

θ1+|θ2|=90°(electrical angle)

To avoid the dead point of the two-phase motor and allow for quick starting, the electrical angles θ1 and θ2 are set based on the above relational equation.

In the present embodiment, the electrical angle θ2 of the B-phase rotor unit 101b relative to the A-phase rotor unit 101a in the counterclockwise direction is set to −45 degrees (counterclockwise direction), and the electrical angle θ1 of the B-phase stator unit 102b relative to the A-phase stator unit 102a in the clockwise direction is set to 45 degrees (clockwise direction).

In the present embodiment, the electrical angle θ2 is set to −45 degrees and the electrical angle θ1 is set to 45 degrees (clockwise direction). However, the electrical angle θ2 and the electrical angle θ1 may be changed within a range that satisfies the above equation.

The operation of the motor 100 will now be described.

In the motor 100 of the present embodiment, input voltage va is applied to the annular windings 161 of the A-phase stator unit 102a, and input voltage vb is applied to the annular windings 161 of the B-phase stator unit 102b. This generates a rotation field at the stator 102 that rotates and drives the rotor 101.

The stator 102 has a two-layer structure including the A-phase stator unit 102a and the B-phase stator unit 102b in correspondence with the input voltage Va and the input voltage Vb. Accordingly, the rotor 101 also has a two-layer structure including the A-phase rotor unit 101a and the B-phase rotor unit 101b. This allows the stator units 102a and rotor units 101a and 101b for each phase to receive the magnetic flux of the annular magnet 130 thereby increasing the output.

A Lundell rotor may have a three-layer structure including, for example, U-phase, V-phase, and W-phase rotors that are stacked. In such a case, among the annular magnets of the U-phase, V-phase, and W-phase rotors, the annular magnets for the rotors of two of the phases are magnetized in the same direction, and the annular magnet for the remaining phase is magnetized in the opposite direction. With regard to the relationship of the U-phase, V-phase, and W-phase rotors, this generates a difference in the magnetic flux of the claw pole for each phase. Thus, in the entire three-layer structure Lundell rotor, the magnetic balance would be greatly disturbed.

In this regard, the rotor 101 of the present embodiment is a two-layer structure including the A-phase rotor unit 101a and the B-phase rotor unit 101b. In the A-phase rotor unit 101a and the B-phase rotor unit 101b, the corresponding annular magnets 130 are magnetized in opposite directions. Thus, in the relationship of the A-phase rotor unit 101a and the B-phase rotor unit 101b, the disturbance in the magnetic balance is small in the claw poles 113 and 123 of the A-phase rotor unit 101a and the claw poles 113 and 123 of the B-phase rotor unit 101b. Since the disturbance in the magnetic balance is small, the motor performance (output performance) can be improved.

Moreover, in the present embodiment, the electrical angle θ1, at which the B-phase stator unit 102b is shifted from the A-phase stator unit 102a in the clockwise direction, and the electrical angle θ2, at which the B-phase rotor unit 101b is shifted from the A-phase rotor unit 101a in the counterclockwise direction, are set to values determined by θ1+|θ2|=90° (electrical angle).

More specifically, in the stator 102, the B-phase stator unit 102b is shifted from the A-phase stator unit 102a by a predetermined electrical angle θ1 (45°) in the clockwise direction as viewed in the direction of the axis L. In the rotor 101, the B-phase rotor unit 101b is shifted from the A-phase rotor unit 101a by a predetermined electrical angle θ2 (45°) in the counterclockwise direction as viewed in the direction of the axis L. This also allows dead points, at which the two-phase motor cannot be activated, to be avoided and enables quicker starting. Further, the movement amount (rotation amount) of the rotor 101 may be increased when the first and second stator claw poles 144 and 154 are switched by the current flowing through the annular windings 161 of the A-phase stator unit 102a and the B-phase stator unit 102b. This allows the rotation speed to be increased.

The phase of the input voltage va of the A-phase stator unit 102a in the stator 102 is retarded by a phase difference of 90° from the phase of the input voltage vb of the B-phase stator unit 102b. That is, the effective flux may decrease when leakage flux is generated between the claw poles 113 and 123 of the A-phase rotor unit 101a and when leakage flux is generated between the claw poles 113 and 123 of the B-phase rotor unit 101a. In this case, the leakage flux distorts the flux distribution, generates vibration, and decreases the output. Thus, the present embodiment has a phase difference of 90° between the phase of the input voltage va of the A-phase stator unit 102a and the phase of the input voltage vb of the B-phase stator unit 102b. The phase difference reduces vibration of the motor 100 and increases the output.

In the stator 102 of the present embodiment, the first spacer 170, which is a magnetic member, is arranged between the arc wall portions 143 of the first stator core 140 and the arc wall portions 153 of the second stator core 150. The first spacer 170 has a lower rigidity than the first stator core 140 and the second stator core 150. The first spacer 170 is applied between the axial end surfaces 143b and 153b when coupling the first stator core 140, the second stator core 150, and the coil 160. The axial end surfaces 143b and 153b apply pressure that deforms the first spacer 170. Thus, the first spacer 170 contacts the axial end surfaces 143b and 153b with the gaps minimized between the first spacer 170 and the axial end surfaces 143b and 153b.

The advantages of the second embodiment will now be described.

(5) The first spacer 170 is deformed so that the first spacer 170 contacts the first stator core 140 and the first spacer 170 contacts the second stator core 150. The first spacer 170 includes a magnetic body. This forms a magnetic path between the first stator core 140 and the second stator core 150. Further, regardless of the machining accuracy of the first stator core 140 and the second stator core 150, the first spacer 170 contacts the first stator core 140 and the first spacer 170 contacts the second stator core 150. This limits the formation of gaps between the first stator core 140 and the second stator core 150 and limits increases in the magnetic resistance.

(6) The first and second stator cores 140 and 150 respectively include the core segments 141 and 151 that are arranged in the circumferential direction. This increase the magnetic resistance between the core segments 141 and the magnetic resistance between the core segments 151 as compared with when using an integral core. As a result, the generation of eddy current may be reduced in the first and second stator cores 140 and 150.

(7) The resin portions 142 and 152, which are non-magnetic members, are arranged between the core segments 141 and 151. This reduces the generation of eddy current in the first and second stator cores 140 and 150.

(8) The second spacer 180, which is a non-magnetic member, is arranged between the stator units 102a and 102b. This reduces the generation of leakage flux between the stator units 102a and 102b.

The second embodiment may be modified as described below.

The resin portions 142 and 152 only need to be non-magnetic members. For example, an adhesive, which also functions to fasten the core segments 141 and the core segments 151, may be used as the non-magnetic member. Further, the resin portions 142 and 152 may be press-fitted between the core segments 141 and 151 to fasten the resin portions 142 and 152 to the core segments 141 and 151.

In the above embodiment, the locations where the first stator core 140 is divided in the circumferential direction are circumferentially middle positions between adjacent claw poles 144, and the locations where the second stator core 150 is divided in the circumferential direction are circumferentially middle positions between adjacent claw poles 154. Instead, for example, the stator cores may be divided at the circumferentially middle position of each of the claw pole 144 and 154 or be divided by combining these structures.

In the above embodiment, the stator cores 140 and 150 are formed by only the core segments 141 and 151. However, for example, the rotor cores 110 and 120 may be formed by core segments. Alternatively, the stator cores 140 and 150 and the rotor cores 110 and 120 may both be formed by core segments.

In the above embodiment, the first and second stator cores 140 and 150 are respectively formed by the core segments 141 and 151 and the resin portions 142 and 152. However, there is no limitation to such a structure.

For example, the resin portions 142 and 152 may be omitted. In this case, the core segments 141 may be arranged in contact with one another in an annular form, and the core segments 151 may be arranged in contact with one another in an annular form. Further, instead of using the core segments 141 and 151, an annular integral core may be used.

The second spacer 180, which is a non-magnetic body, does not have to be arranged between the A-phase stator unit 102a and the B-phase stator unit 102b, which form the stator 102. For example, the second spacer 180 may be omitted, and the A-phase stator unit 102a and the B-phase stator unit 102b may directly contact each other.

The second spacer 180 does not have to be annular. For example, a plurality of arcuate second spacers may be arranged in the circumferential direction.

The first spacer 170 does not have to be formed by an adhesive that contains a magnetic body. For example, the first spacer 170 may be formed by a magnetic rubber sheet containing a magnetic body or a resin containing a magnetic body.

The first spacer 170 does not have to be annular. For example, an arcuate first spacer may be used. In this case, an arcuate first space member may be arranged in contact with the arc wall portions 143 of the first stator core 140 and the arc wall portions 153 of the second stator core 150 in the axial direction but not in contact with the resin portions 142 and 152 in the axial direction.

The stator 102 does not have to include the A-phase stator unit 102a and the B-phase stator unit 102b. For example, the stator 102 may be formed by a single stator unit. Alternatively, the stator 102 may be formed by stator units for three or more phases (layers). In this case, it is preferred that the rotor 101 also be changed to have the same number of phases (layers) as the stator 102.

The rotor 101 and the stator 102 both do not have to have the Lundell structure. For example, only the stator 102 may have a Lundell (claw pole) structure, and the stator 102 may have a surface permanent magnet (SPM) structure or an interior permanent magnet (IPM) structure.

The above embodiment and each modification may be combined.

1. A multi-Lundell motor comprising:
a rotor including first and second rotor cores, each including a plurality of claw poles in a circumferential direction, and a permanent magnet, which is located between the first and second rotor cores and magnetized in an axial direction; and
a stator including first and second stator cores, each including a plurality of claw poles in the circumferential direction, and a winding, which is located between the first and second stator cores and extended in the circumferential direction;
wherein at least one of the first and second rotor cores and the first and second stator cores include a plurality of core segments arranged in the circumferential direction.

2. The multi-Lundell motor according to claim 1, wherein a resin portion is arranged between the core segments.

3. The multi-Lundell motor according to claim 1, wherein the core segments are separated between the claw poles and/or at a circumferential center of each of the claw poles.

4. The multi-Lundell motor according to claim 2, wherein
each of the core segments includes a circumferential outer surface defining a core engagement portion that is recessed in the circumferential direction, and
the resin portion includes a resin engagement portion that engages the core engagement portion.

5. The multi-Lundell motor according to claim 2, further comprising an annular member, wherein
among the first and second rotor cores and the first and second stator cores, a core located at an outer side in a radial direction is referred to as an outer core;
the annular member is arranged at a radially outer side of the outer core; and
the resin portion is press-fitted between the core segments that form the outer core to integrate the annular member and the outer core.

6. The multi-Lundell motor according to claim 2, wherein the resin portion is configured to project further from an axial surface of the core segment.

7. The multi-Lundell motor according to claim 2, wherein the core segment is entirely coated with resin to arrange the resin portion between the core segments.

8. The multi-Lundell motor according to claim 2, wherein the core segments are separated from each other and arranged in an annular form, and resin is subjected to insert molding to entirely cover the core segments and integrate the core segments.

9. The multi-Lundell motor according to claim 1, wherein a conductor that supplies current to the winding is arranged between the core segments of the stator.

10. The multi-Lundell motor according to claim 9, wherein an insulation member that insulates the conductor from the core segments is arranged between the conductor and the core segments.

11. The multi-Lundell motor according to claim 9, wherein the winding is divided between the claw poles and/or at a circumferential center of each of the claw poles.

12. The multi-Lundell motor according to claim 1, wherein the winding is configured by electrically connecting a plurality of conductor segments in the circumferential direction, wherein the conductor segments are separated from each other at the same location in the circumferential direction as the core segments.

13. The multi-Lundell motor according to claim 12, wherein a circuit section including a switching element is arranged between the conductor segments.

14. The multi-Lundell motor according to claim 1, further comprising a magnetic member arranged between the first stator core and the second stator core in the axial direction, wherein the magnetic member is deformed so that the magnetic member contacts the first stator core and the magnetic member contacts the second stator core.

15. The multi-Lundell motor according to claim 14, wherein the first and second stator cores each include a plurality of core segments arranged in the circumferential direction.

16. The multi-Lundell motor according to claim 15, wherein a non-magnetic member is arranged between the core segments.

17. The multi-Lundell motor according to claim 14, wherein
the first stator core, the second stator core, and the winding form a single stator unit,
the stator unit is one of a plurality of stator units,
the stator units are arranged in the axial direction, and
a non-magnetic member is arranged between the stator units in the axial direction.
